(19) United States
(12) Patent Application Publication
(10) Pub. No.: US 2024/0370854 A1
(43) Pub. Date: Nov. 7, 2024

(54) Systems And Methods For Privacy-Enhanced Digital Wallet Verification

(71) Applicant: Frontage Road Holdings, LLC, Wilmington, DE (US)

(72) Inventors: Josh Williams, Sacramento, CA (US); Bela Nikhilray Pandya, San Ramon, CA (US); Christopher Alan Jimison, Concord, CA (US)

(21) Appl. No.: 18/654,338

(22) Filed: May 3, 2024

Related U.S. Application Data
(60) Provisional application No. 63/500,346, filed on May 5, 2023.

(51) Int. Cl. G06Q 20/36; G06Q 20/40

(52) U.S. Cl. CPC G06Q 20/3674; G06Q 20/4016

(57) ABSTRACT

Embodiments include systems and methods for electronic wallet verification. In an embodiment, a blockchain computer system for real-time electronic wallet verification includes a fraud prevention computer system. The fraud prevention computer system is configured to protect user privacy and includes a virtual machine (VM) with a blockchain oracle. The blockchain oracle is configured to bridge one or more off-chain compliance and privacy protection interfaces. The virtual machine (VM) is configured to decode, via a decoder, a first smart contract on a blockchain computer network. The first smart contract on the blockchain computer network, in response to receiving a compliance check request including an electronic wallet, is configured to verify the electronic wallet by dynamically querying the one or more off-chain compliance and privacy protection interfaces for the electronic wallet via the blockchain oracle.

### RELATED APPLICATION

This application claims the benefit of U.S. Provisional Application No. 63/500,346, filed on May 5, 2023, the entire teachings of which are incorporated herein by reference.

### BACKGROUND

A blockchain may be implemented as a peer-to-peer (P2P), electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

Blockchain may be used for implementation of “smart contracts” that can be associated with digital asset. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets.

An area of blockchain-related interest is the use of “tokens” to represent and transfer assets via the blockchain. A token serves as an identifier that allows an asset to be referenced from the blockchain. Fungible tokens are uniform. In other words, fungible tokens of the same type are identical in specification, and each fungible token is identical to another fungible token of the same type. Fungible tokens may be divisible into smaller amounts. Similar to currency, where bills can be divided into coins of an equivalent value, fungible tokens may be divisible. Non-fungible tokens (NFTs), however, cannot be replaced with other tokens of the same type. NFTs represent non-fungible assets. Non-fungible assets have unique information or attributes. Each NFT is unique and differs from other tokens of the same class, and, unlike a fungible token, NFTs typically cannot be divided. Blockchain gaming systems may use tokens or NFTs to create different parts of the game, such as rules, characters, weapons, and skins.

Cryptocurrency wallets may be implemented to securely store and manage blockchain assets, tokens, NFTs, and cryptocurrencies. These wallets may allow users to spend, receive, and trade digital assets.

### SUMMARY

While blockchain technology can help ensure security due to its principles of cryptography, decentralization, and consensus, the transaction processing components, such as cryptocurrency exchanges, can be vulnerability to illicit activity and privacy invasions. Like financial services, cryptocurrency exchanges may adhere to certain compliance standards, such as Know Your Customer (KYC). Such compliance standards may include requirements concerning a customer's identity, financial activities and risk, and may compromise the privacy of a user.

To improve blockchain transaction security, electronic wallets should be verified with compliance standards to help prevent malicious and fraudulent transactions. Conventional approaches for engaging in digital asset transactions among digital wallets on a blockchain, however, lack functionality for verifying an electronic wallet that may potentially participate in a transaction. Further, there may be privacy concerns if compliance and security measures are enforced in electronic wallet verification, and transaction processing speed may be compromised as a result of enforcement.

The present disclosure provides electronic wallet verification computer systems that help protect user privacy, maximize security compliance and minimize user friction, without compromising electronic wallet verification and digital asset transaction processing speed and efficiency. Aspects of the present disclosure can improve blockchain transaction security with the disclosed frictionless electronic wallet verification computer-based systems. For example, certain embodiments provide solutions for confirming that an electronic wallet adheres to various compliance rules, such as KYC, Know Your Wallet (KYW), or anti-money laundering (AML) standards. The present disclosure provides a computer-based system for frictionless electronic wallet verification to case digital asset transactions.

An example embodiment is directed to a blockchain computer system for real-time electronic wallet verification. In an embodiment, the blockchain computer system may include a fraud prevention computer system. According to an embodiment, the fraud prevention computer system may be configured to protect user privacy. In an example embodiment, the fraud prevention computer system may include a virtual machine (VM) with a blockchain oracle. According to one such embodiment, the blockchain oracle may be configured to bridge one or more off-chain compliance and privacy protection interfaces. In an embodiment, the virtual machine (VM) may be configured to decode, via a decoder, a first smart contract on a blockchain computer network. According to an example embodiment, the blockchain computer network may be, e.g., Ethereum, Tezos, Stellar, Hyperledger Fabric, ConsenSys Quorum, or any other blockchain or distributed ledger network known to those of skill in the art. To continue, in an embodiment, the first smart contract on the blockchain computer network, in response to receiving a compliance check request relating to an electronic wallet, may be configured to verify the electronic wallet by dynamically querying the one or more off-chain compliance and privacy protection interfaces for the electronic wallet via the blockchain oracle.

In an example embodiment, the compliance check request may be received from a second smart contract on the blockchain computer network. According to one such embodiment, the first smart contract on the blockchain computer network may be further configured to transmit a message to the second smart contract on the blockchain computer network. In an embodiment, the message may indicate a verification status of the electronic wallet. According to an embodiment, the verification status based on a result of verifying the electronic wallet.

In an embodiment, the compliance check request may relate to a digital asset transaction. According to an example embodiment, the digital asset may be a non-fungible token (NFT). In another embodiment, the digital asset may be, e.g., cryptocurrency, such as Ethereum (ETH) or Bitcoin (BTC). Further, in yet another example embodiment, the digital asset transaction or the digital asset may be disabled in response to dynamically querying the one or more off-chain compliance and privacy protection interfaces indicating that the electronic wallet is not verified.

In an example embodiment, dynamically querying the one or more off-chain compliance and privacy protection interfaces via the blockchain oracle may exclude user and personal information associated with the electronic wallet to protect user privacy. According to an embodiment, the first smart contract on the blockchain computer network may be further configured with a zero-knowledge proof (ZKP) to verify that user and personal information associated with the electronic wallet is not included with the compliance check request.

In an embodiment, the one or more off-chain compliance and privacy protection interfaces may include an external sanctions database configured to store unique electronic wallet identifiers. According to an example embodiment, the external sanctions database may be an Office of Foreign Assets Control (OFAC) sanctions list. Further, in yet another embodiment, the first smart contract on the blockchain computer network may be further configured to store one or more unique electronic wallet identifiers retrieved from the external sanctions database in an on-chain sanctions map of the blockchain computer network.

In an example embodiment, the one or more off-chain compliance and privacy protection interfaces may include an external application programming interface (API). The external API may be, e.g., a Hypertext Transfer Protocol Secure (HTTPS) representational state transfer (REST) API, or any other suitable API known to those of skill in the art. Further, in another embodiment, dynamically querying the one or more off-chain compliance and privacy protection interfaces for the electronic wallet via the blockchain oracle may include receiving a message from the external application programming interface (API). According to an embodiment, the message may indicate a screening status of the electronic wallet. In an example embodiment, the screening status may indicate that a node associated with the electronic wallet is blocked or approved by a blockchain application. Further, in yet another example embodiment, the first smart contract on the blockchain computer network may be further configured to store a record indicating the screening status in one or more on-chain screening maps of the blockchain computer network.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is block diagram of an example implementation of a network in communication with an embodiment.

FIG. 1B is block diagram of any internal structure of a computer/computing node in a processing environment of an embodiment.

FIG. 2A is a block diagram showing an example device authentication system according to an embodiment.

FIG. 2B is a diagram showing an example device authentication system according to an embodiment.

FIG. 2C is a diagram of device authentication system components according to an embodiment.

FIG. 2D is a diagram of example interfaces according to an embodiment.

FIG. 3A is a diagram of a sequence of packaging and delivering an instruction by an encoder according to an embodiment.

FIG. 3B is a diagram of a device enrollment process according to an embodiment.

FIGS. 4A-4B are block diagrams illustrating exemplary system components for an electronic wallet verification system according to an embodiment.

FIG. 5 is a block diagram showing exemplary blockchain layers according to an embodiment.

FIG. 6A is a flowchart diagram of an exemplary sequence of checking an electronic wallet by the electronic wallet verification system according to an embodiment.

FIG. 6B is a flowchart diagram of an exemplary of checking an electronic wallet and blocking an electronic wallet by the electronic wallet verification system according to an embodiment.

FIG. 6C is a flowchart diagram of an exemplary sequence of checking an electronic wallet and approving an electronic wallet by the electronic wallet verification system according to an embodiment.

FIG. 6D is a flowchart diagram of an exemplary sequence of checking an electronic wallet by the electronic wallet verification system using asynchronous communication according to an embodiment.

FIG. 7 is a block diagram of an example user identification system according to an embodiment.

FIG. 8 is a block diagram of an example embodiment of a distributed blockchain ledger computer-implemented system.

FIG. 9 is a flow diagram of an exemplary computer-based system/method for multinetwork digital asset control according to an embodiment.

### DETAILED DESCRIPTION

A description of example embodiments follows.

In general, blockchain is a write-once, append-many type electronic ledger. Blockchain is an architecture that allows disparate users to make transactions and creates an unchangeable record of those transactions. To move anything of value over any kind of blockchain, a network of nodes must first agree that a corresponding transaction is valid. As a peer-to-peer (P2P) network, combined with a distributed time-stamping server, blockchain ledgers can be managed autonomously to exchange information between disparate parties; there is no need for an administrator. In effect, the blockchain users are the administrator.

Blockchain's rapid development has given rise to many different kinds of chains, leading to cross-chain technology. Cross-chain, as its name suggests, allows the transmission of value and information between different blockchains. According to an example embodiment, a digital asset may be exchanged, cross-chain, securely, and despite differences between constraints or rules of operation that may be established for the different blockchains. Such a digital asset may be in the form of a token, which may be fungible, or may be a non-fungible token (NFT). Such constraints or rules may be in the form of smart contracts, or other forms. Differences between such constraints or rules may include disparate levels of rigor or leniency of such constraints or rules between or among different blockchain networks.

In some embodiments, blockchain may be a P2P, electronic ledger that is implemented as a computer-based decentralized, distributed system made up of blocks, which, in turn, are made up of transactions. Each transaction may be a data structure that encodes a transfer of control of a digital asset between participants in the blockchain system, and that includes at least one input and at least one output. Each block may contain a hash of a previous block so that blocks become chained together to create a permanent, unalterable record of all transactions that have been written to the blockchain since its inception. Transactions may contain small programs, known as scripts, embedded into their inputs and outputs; the scripts may specify how and by whom the outputs of the transactions can be accessed.

For a transaction to be written to the blockchain, it must be “validated.” Network nodes (miners) may perform work to ensure that each transaction is valid, with invalid transactions being rejected from the network. Software clients installed on the nodes may perform this validation work on an unspent transaction (UTXO) by executing its locking and unlocking scripts. If execution of the locking and unlocking scripts evaluates to TRUE, the transaction is valid and is written to the blockchain. Thus, for a transaction to be written to the blockchain, it should be: (i) validated by a first node that receives the transaction—e.g., if the transaction is validated, the node relays it to other nodes in the network; (ii) added to a new block built by a miner; and (iii) mined, e.g., added to the public ledger of past transactions.

Blockchain may be used for implementation of “smart contracts” that can be associated with digital assets. These are computer programs designed to automate execution of terms of a machine-readable contract or agreement. Unlike a traditional contract, which would be written in natural language, a smart contract is a machine-executable program that may include rules for processing inputs to generate results; these results may then cause actions to be performed depending upon those results. With respect to commercial transactions, for example, these may involve a transfer of property rights and/or assets. Such assets may include real property, personal property (including both tangible and intangible property), digital assets such as software, or any other type of asset. In the digital economy, there is often an expectation that exchanges and transfers will be performed in a timely manner and across vast distances. This expectation, along with practical, technical limitations, means that traditional forms of asset transfer, such as physical delivery of hardcopy of documents representing a contract, negotiable instrument, etc., or a tangible asset itself, are not desirable. Thus, smart contracts can provide enhanced control, efficiency, and speed of transfer.

An area of blockchain-related interest is the use of “tokens” to represent and transfer assets via the blockchain. A token thus serves as an identifier that allows the real-world item to be referenced from the blockchain. Through an Initial Coin Offering (ICO) model, startups can raise capital by issuing tokens on a blockchain, such as Ethereum, and distributing them to token buyers in exchange for making a financial contribution to a project. These tokens, which can be transferred across a network and traded on cryptocurrency exchanges, can serve a multitude of different functions, from granting holders access to a service to entitling them to company dividends. Depending on their function, tokens may be classified as security tokens or utility tokens.

Tokens may be used, for instance, in an initial public offering (IPO) to issue, e.g., company shares, dividends, and/or voting rights over blockchain networks. The tokens may include, e.g., security tokens and/or utility tokens. The security tokens may be associated with a value that is derived from a tradable asset and, thus, may be deemed a security token that may be subject to federal laws regulating traditional securities. In contrast, the utility tokens may represent future access to a company's product(s) and/or service(s). A defining characteristic of the utility token is that it is not designed as an investment. Because a utility token is not issued in the form of an investment asset, it may be exempt from having to comply with federal legislation regulating securities.

Further, similar to physical assets, the tokens that represent them may have many properties, one of which is fungibility or non-fungibility. In economics, fungibility refers to the equivalence or interchangeability of each unit of a commodity with other units of the same commodity. Fungible tokens (FTs) are tokens that can be exchanged for any other token with the same value.

Fungible tokens are uniform, that is, FTs of the same type are identical in specification. In other words, each FT is identical to another FT of the same type, and FTs are divisible into smaller amounts. Similar to currency, where bills can be divided into coins of an equivalent value, FTs are divisible. As such, a fraction of an FT can be transferred between users. NFTs, however, cannot be replaced with other tokens of the same type. NFTs represent nonfungible assets, e.g., assets that have unique information or attributes. Each NFT is unique and differs from other tokens of the same class. For example, while plane tickets from and to a same destination may look the same, each one has a different passenger name, seat number, etc., and, therefore, is unique. In contrast to FTs, NFTs cannot be divided, an elementary unit of the NFT is the token itself. However, fractional ownership of NFTs is also possible. Fractional ownership allows a NFT to be divided into smaller NFTs.

Due to an immutable nature of transaction histories supported by blockchain networks, it is possible to extend the aforementioned validation steps of such transactions so that the transactions become subject to certain rules that reference prior transactions, or even aspects of an initial creation of a subject digital asset, e.g., a NFT. An example of such rules is an arrangement wherein royalties are paid to a creator of a digital asset each time the digital asset is sold to a subsequent owner. Such royalty payment arrangements may be implemented as a function with which the blockchain network is programmed, or using a reference table loaded into a computer memory element of the blockchain network, as a smart contract as described hereinabove, or by other means.

A further use case for cryptocurrency exchanges on a blockchain network is that such exchanges can protect transactions—similar to a manner in which a surety bond would. A surety bond or surety is a promise by a surety or guarantor to pay one party a certain amount if a second party fails to meet some obligation, such as fulfilling terms of a contract. The surety bond protects an obligee against losses resulting from a principal's failure to meet the obligation. As cryptocurrencies evolve from fringe investments to mainstream instruments, surety bonds may become an increasingly common requirement for those looking to trade in virtual currencies.

Ordinary surety bonds act as a contract between three parties: (i) an entity requesting the bond (principal), (ii) the bond's beneficiary (obligee), and (iii) a company issuing the bond. What a surety bond does is guarantee that the principal will fulfill its obligations, whether it's completing a long-term project or processing a financial transaction, or else forfeit the bond. Cryptocurrency surety bonds work in the same basic manner, ensuring that the principal performs cryptocurrency transactions as expected, or else forfeits the bond. In this case, the contract is between an entity handling a virtual currency transaction, a regulatory entity requiring the surety bond, and a surety bond provider.

In an example embodiment, a digital asset exchange platform may leverage an electronic wallet verification system to enforce a contract governing transfer of tokens between electronic wallets. The contract may specify royalties to be paid to the original creator of a token upon transactions involving that token. The contract may include a revenue share table. The electronic wallet verification system may be configured to enforce the contract regardless of the network locations of two parties involved in a transaction, and regardless of whether or not the transaction is conducted within the digital asset exchange platform. For example, even offline exchanges are made transparently viewable from within the digital asset exchange platform. The electronic wallet verification system may be configured to serve any token creator.

According to another example embodiment, upon creation of a token, a threshold value of that token may be set within the digital asset exchange platform. The electronic wallet verification system may implement rules in conjunction with the threshold value to prevent the value of the token from experiencing dramatic changes characteristic of backdoor or offline transactions. As such, the threshold value may act as a floor price of the token required to activate any transaction involving the token. The electronic wallet verification system may manage and approve or deny transactions accordingly. Rules such as threshold values may be based on a bounded percentage of a price change from a previous transaction. Such a clearinghouse can be implemented in a decentralized manner, such as with a smart contract. A central authority is thus not required.

In an example embodiment, a digital wallet, such as a hybrid multisignature electronic wallet, may employ an electronic wallet verification system to allow a licensed custodian or designee to provide signatures or keys required to approve a digital transaction. The custodian may approve transfers of tokens on digital exchange platforms such as blockchain platforms. A set of custodian signatures, potentially from multiple custodians, may be required to approve a transaction. Alternatively, the hybrid multisignature wallet may be configured in a one-of-many or a one-of-one setup, requiring only a single signature of one or more valid signatures from one or more custodians to approve the transaction. If a network allows a designated party to be a custodian, that party may enter into an agreement at the protocol level on the network to become a designated custodian. The hybrid multisignature wallet may be implemented in support of compliance operations via an electronic wallet verification system. The custodian may facilitate recovery or replacement of lost signatures or keys, or of entire lost wallets.

According to another example embodiment, hybrid multisignature wallet may support transactions such as token swaps, and may facilitate transfer of tokens across multiple networks. Individual networks of the multiple networks may utilize an electronic wallet verification system to implement rigorous or lenient constraints upon transactions performed within the respective networks. Thus, a disparity may exist between two networks involved in a token transfer. The custodian may facilitate management of such a disparity. The custodian may perform functions characteristic of an automated escrow service in conjunction with a digital exchange platform.

In an example embodiment, a composable digital asset integrates two or more individual digital assets into a new combined form, which may be referred to as an asset cluster. An asset cluster may include components of similar or different types. For example, an asset cluster may include an element of fungible currency such as cryptocurrency, along with a NFT. Thus, combining an amount of cryptocurrency with an NFT effectively establishes a floor price for the NFT equal to the value of the fungible cryptocurrency.

Such composable assets may find applications in areas such as finance and gaming. An example embodiment of a gaming application of composable digital assets involves a piece of armor having a socket, into which a gem may be placed, creating an asset cluster. Asset clusters may be decomposed at any time such that the NFT and the currency item again become separate entities on a digital exchange platform.

Composable digital assets can provide liquidity for any digital asset or token. For example, a player of a game incorporating composable digital asset clusters may use a currency component of a cluster to set an instantaneous price at which to sell the cluster, such as to an automatic market maker (AMM) associated with the game. Composable assets may be referenced or required by contracts or rules governing transactions on a digital exchange platform, such as smart contracts, including smart contracts implemented as part of an electronic wallet verification system.

An AMM cryptographic system may be configured to provide liquidity to a platform facilitating exchange of digital assets as described herein. The exchange platform may be decentralized. Liquidity may be provided using underlying collateral. The AMM cryptographic system can take in and store different forms of digital assets, such as loans, to be used as collateral in future exchanges on the platform. Such assets may be aggregated within a collateral pool, such that liquidity is pooled in association with the exchange platform. Liquidity may thus be pooled and aggregated on a blockchain supporting the collateral pool. Assets may be withdrawn from the collateral pool upon minting a collateral token. The collateral token can thus consolidate liquidity for an exchange within one protocol or contract. In addition, the collateral token may provide liquidity for a one-to-one exchange with a user looking to sell or redeem a user-held token.

In an example embodiment, an electronic wallet verification system program implemented upon a digital asset exchange platform may be configured to force an exchange to be performed on the platform such that the exchange is managed by an AMM cryptographic system. A machine learning (ML) oracle of the AMM cryptographic system may set a computational value for a collateral token, and may offer the collateral token for exchange at such a price, thus computing the market value for that token, rather than deferring to market forces. The AMM cryptographic system may function with either a bounded or unbounded token supply, providing continuous liquidity. In addition, the AMM cryptographic system may be configured to measure supply and demand for tokens on the digital asset exchange platform, including collateral tokens. The AMM cryptographic system may be configured with an encoder/decoder. The AMM cryptographic system encoder may also be configured to mint and/or encode collateral tokens.

The AMM cryptographic system may be implemented by any suitable protocol known to those of skill in the art, such as ERC-20 (Ethereum Request for Comments issue number 20), among other examples.

Certain embodiments provide a system and method for supporting “know your wallet” (KYW) compliance to ease digital asset transactions. In some embodiments, two smart contracts on a blockchain computer network communicate with each other. According to an embodiment, one of the smart contracts may include a NFT or other digital asset on a mainnet network. In an example embodiment, the other smart contract may use a blockchain oracle to query a database, e.g., an Office of Foreign Asset Control (OFAC) database including digital wallet information such as a list of sanctioned electronic wallet addresses. According to an embodiment, the query results may then be cross-checked against a list of potential electronic wallets looking to transact with a developer. Such cross-checking ensures that no violation of compliance rules occurs.

Further, certain embodiments of the electronic wallet verification system and method described herein provide a solution for cross-checking or screening electronic wallet against known sanctioned wallet lists, as well as screening/filtering electronic wallet against on-chain lists for allowed/approved or blocked users.

Some embodiments disclosed herein may be run via deployed smart contracts, and may be supported by a blockchain oracle. The electronic wallet verification system of certain embodiments allows smart contracts and other services to validate if an electronic wallet is valid for usage.

Although one goal of the electronic wallet verification system is to ensure that, e.g., OFAC blocked or sanctioned wallets are not accessed by the system, embodiments are not so limited. Rather, some embodiments may also provide, for example, general blocked and/or allowed/approved wallet lists.

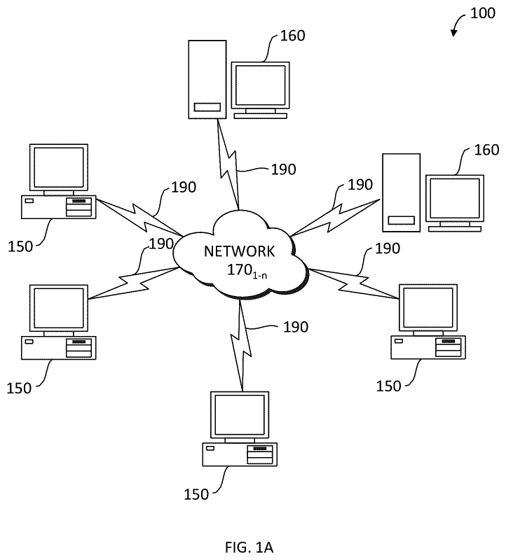

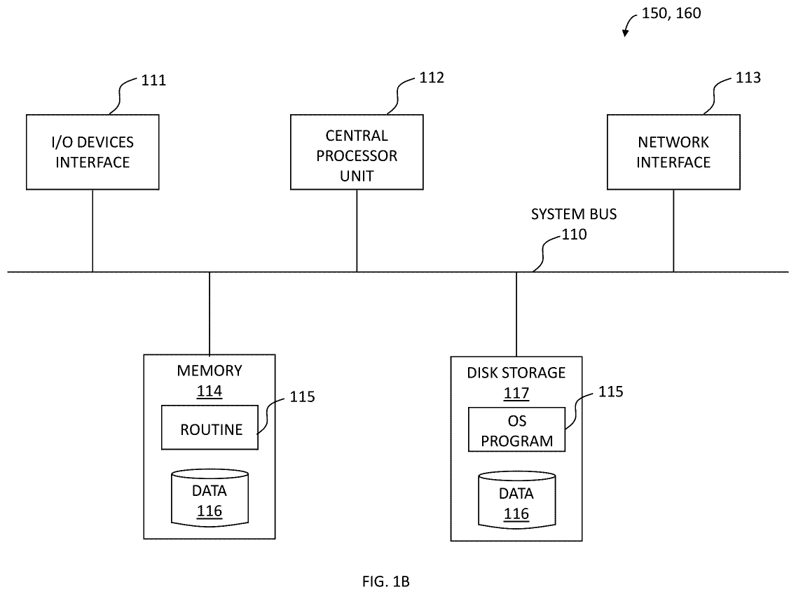

An example implementation of an electronic wallet verification system to provide added security and fraud verification may be implemented in a software, firmware, and/or hardware environment. FIG. 1A illustrates one such example digital processing environment in which embodiments of the present disclosure may be implemented. Client computer(s)/device(s) 150 and server computer(s)/device(s) 160 provide processing, storage, and I/O (input/output) devices executing application programs and the like.

The client computer(s)/device(s) 150 may be linked 190 directly or through communications network(s) 170₁₋ₙ to other computing devices, including other client computer(s)/device(s) 150 and/or server computer(s)/device(s) 160. Referring to FIGS. 1A and 1B (the latter described in more detail hereinbelow), the network(s) 170₁₋ₙ utilize an electronic wallet verification system 100 according to an embodiment of the invention, for ensuring rules compliance, preventing fraud, and/or protecting privacy, thereby casing digital asset transactions.

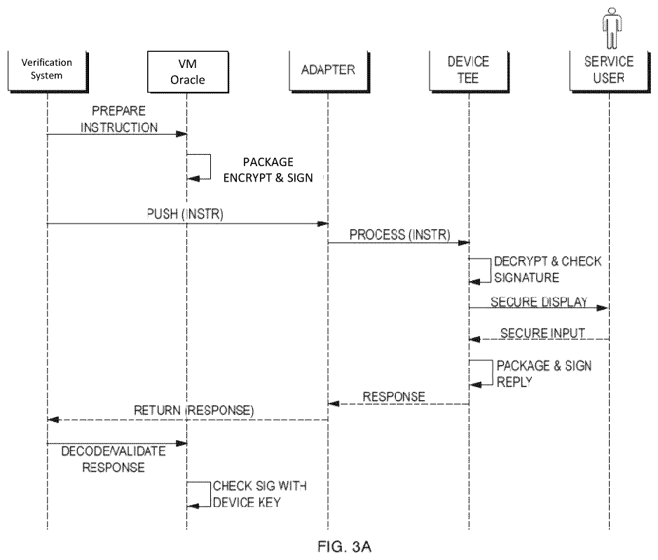

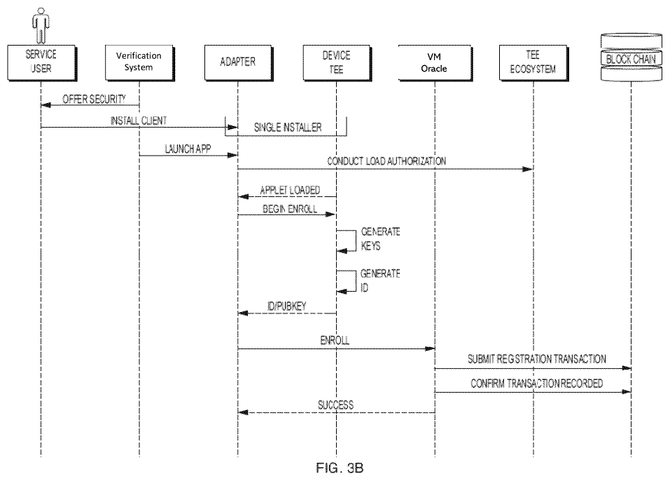

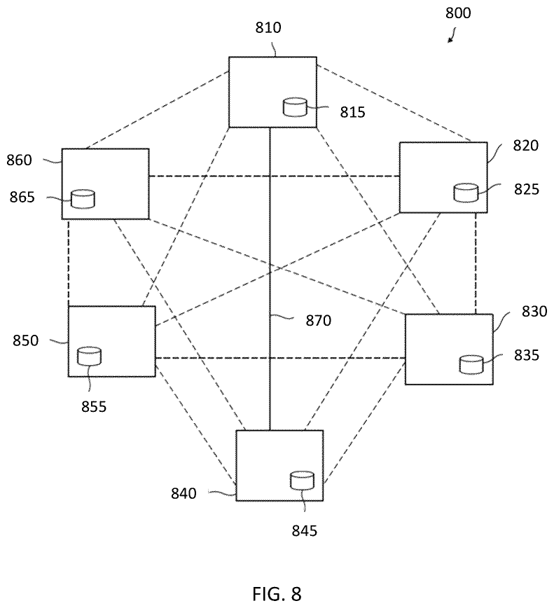

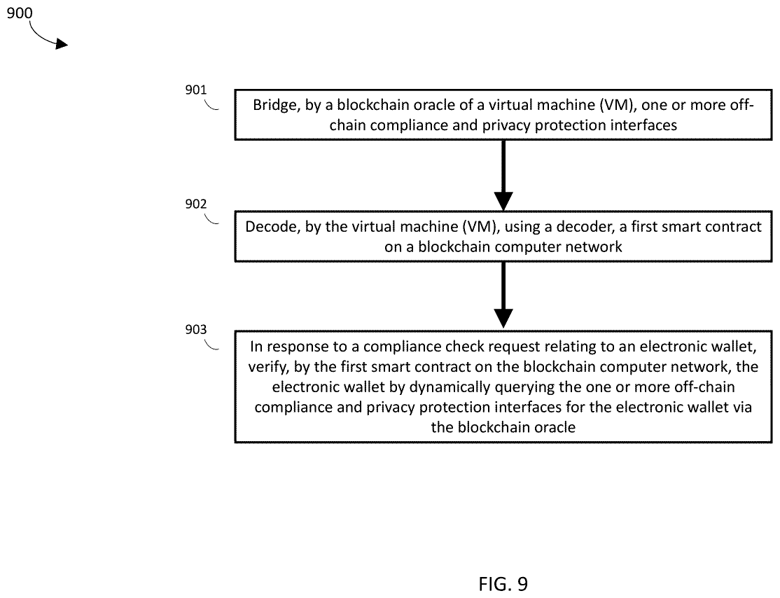

The communications network(s) 170₁₋ₙ may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Moreover, the communications network(s) 170₁₋ₙ may also be a virtual private network (VPN) or an out-of-band (OOB) network or both. In addition, the communications network(s) 170₁₋ₙ may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, the client computer(s)/device(s) 150 may include the nodes shown in FIG. 8 (described in more detail hereinbelow), which may run user applications that enable a user to communicate with an application to determine whether a user meets a work requirement. A blockchain network may be configured on each user device 810, 820 (FIG. 8) to store tokens. The client computers 850 (FIG. 3) of the system 100 (FIG. 1A) or computer-based system/method 900 (FIG. 9) may be configured with a trusted execution environment (TEE) or Trusted Platform Module (TPM), where the application may be run and digital assets and/or tokens may be stored.

Referring again to FIG. 1A, the server computer(s)/device(s) 160 of the system 100 or the computer-based system/method 900 may be configured to include a server that that executes an application. For example, the application of server computer(s)/device(s) 160 may be configured to provide an electronic wallet verification system 100 that ensures adherence to compliance rules and/or prevents fraud in digital asset transactions. The server computer(s)/device(s) 160 may not be separate server computers, but instead may be part of a cloud service. For another example, the server computer(s)/device(s) 160 or the client computer(s)/device(s) 150 may include peer computing devices (nodes) 810, 820, 830, 840, 850, 860 of distributed blockchain ledger 800 of FIG. 8, which may use smart contracts to execute and record transactions implemented via tokens.

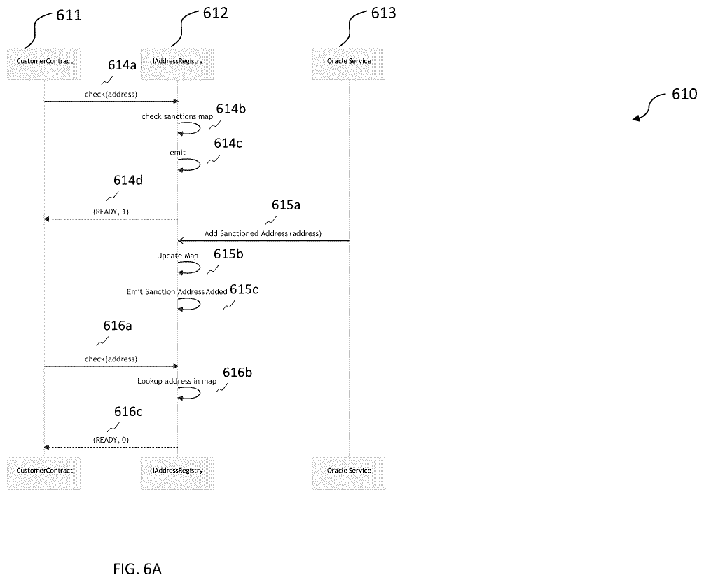

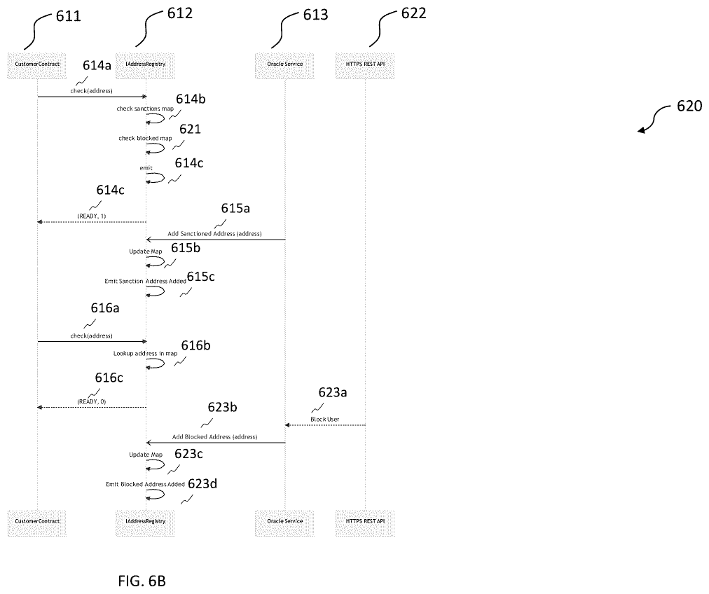

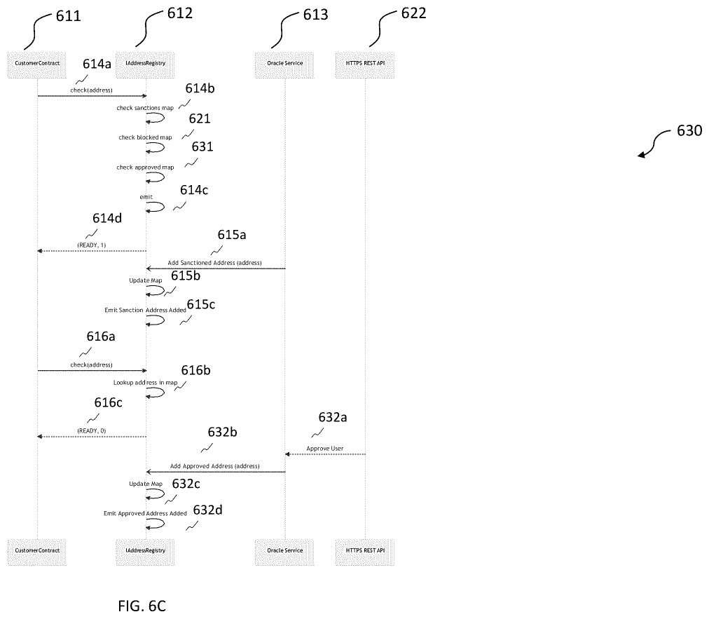

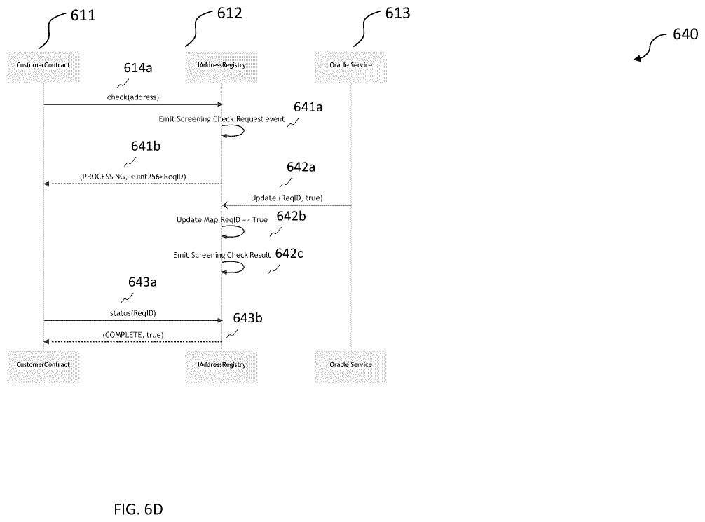

FIG. 6 is a block diagram of any internal structure of a computing/processing node (e.g., the client computer(s)/device(s) 150 or server computer(s)/device(s) 160) in the processing environment 100 of FIG. 1A, which may be used to facilitate displaying audio, image, video, and/or data signal information. Each computer/device 150, 160 in FIG. 1B may contain a system bus 110, where a bus is a set of actual or virtual hardware lines used for data transfer among components of a computer or processing system. The system bus 110 may essentially be a shared conduit that connects different elements of a computer system (e.g., processor, disk storage, memory, I/O ports, etc.), thereby enabling transfer of data between elements or components.

Continuing with FIG. 1B, attached to the system bus 110 is an I/O device interface 111 for connecting various input and output devices (e.g., keyboard, mouse, touch screen interface, displays, printers, speakers, audio inputs and outputs, video inputs and outputs, microphone jacks, etc.) to a computer/device 150, 160. A network interface 113 may allow a computer/device to connect to various other devices attached to a network, e.g., network 870 of FIG. 8. A memory 114 may provide volatile storage for computer software instructions 115 and data 116 used in some embodiments to implement software modules/components of the system 100 (FIG. 1) or the system/method 900 (FIG. 9).

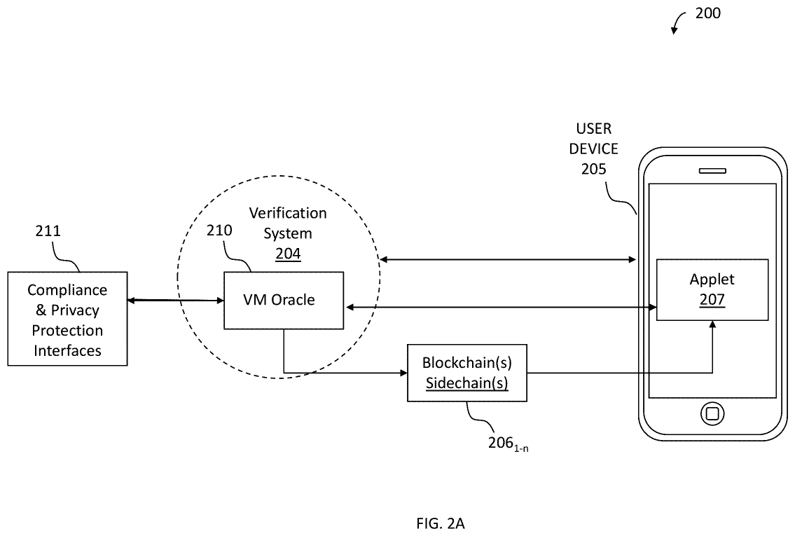

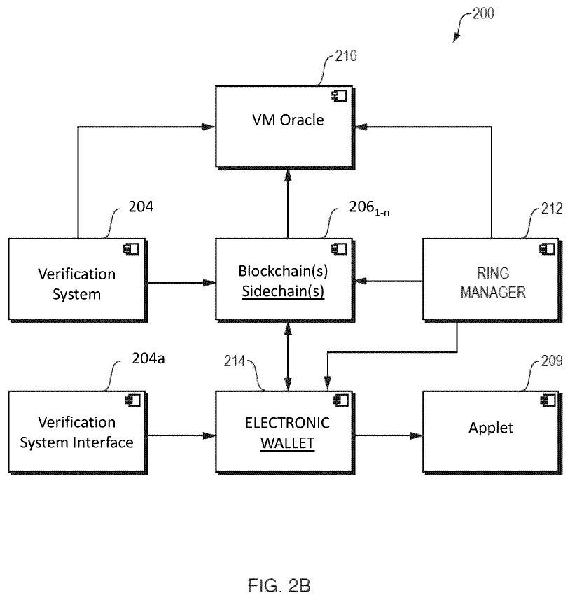

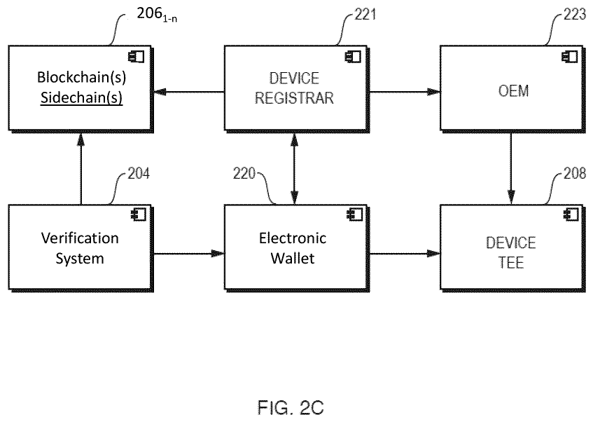

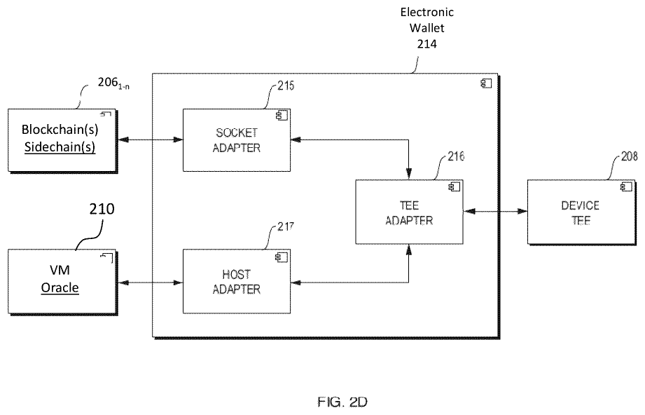

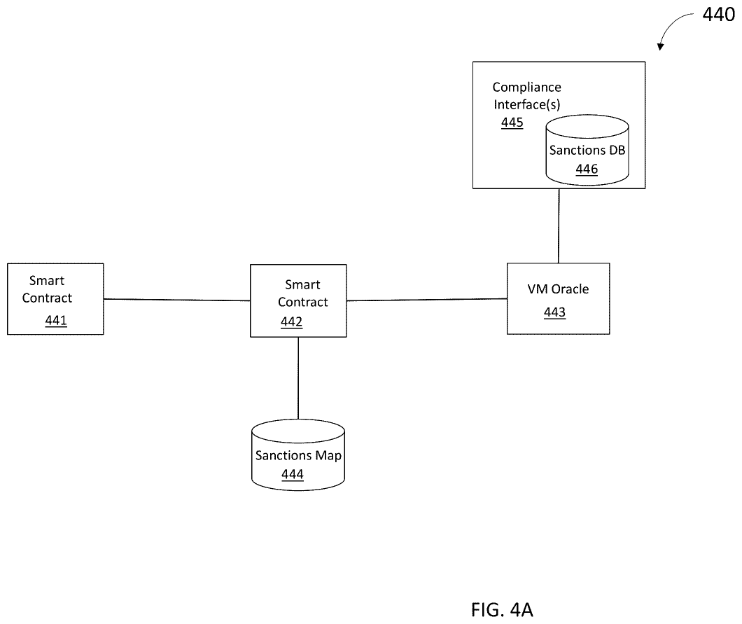

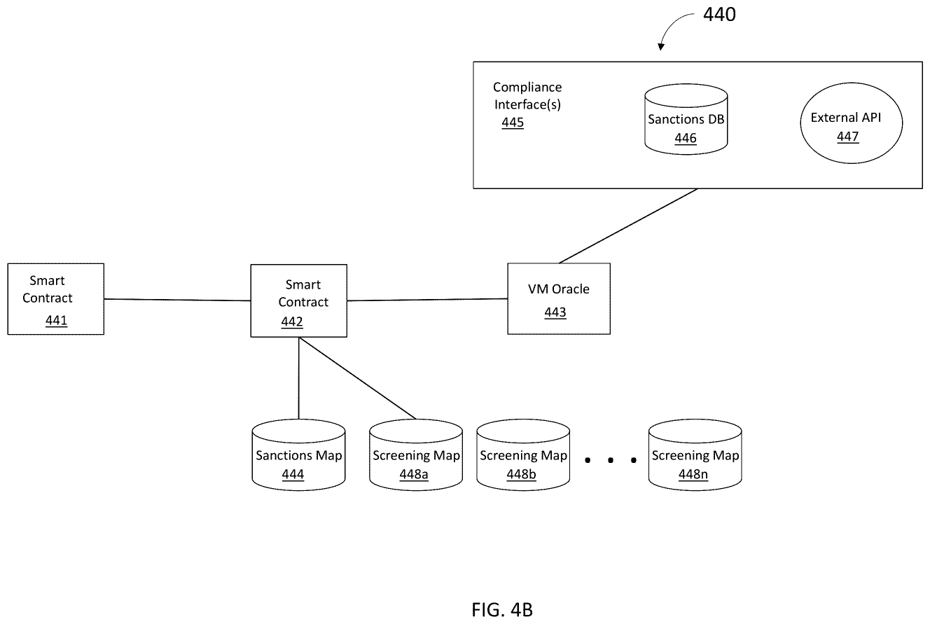

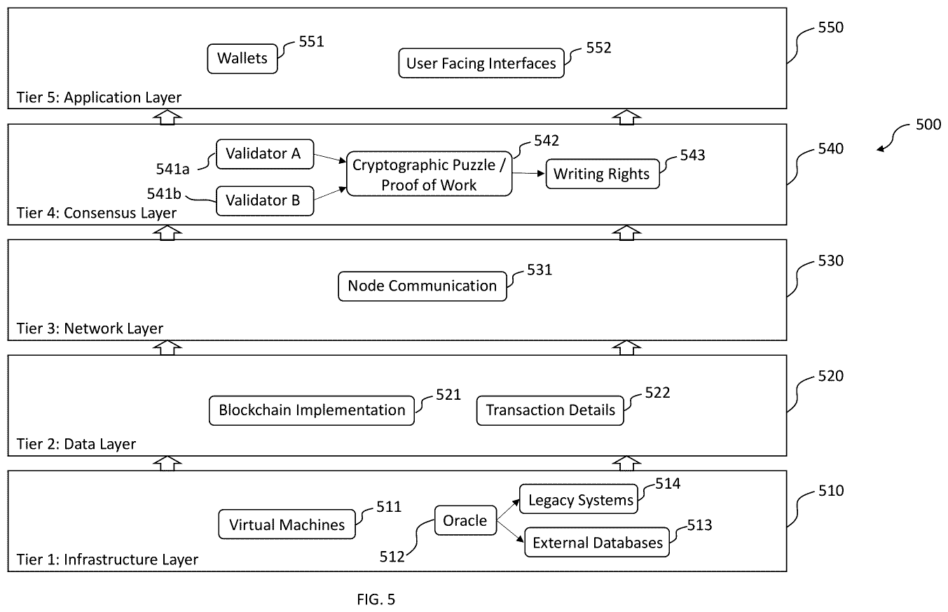

The software components 115, 116 of the system 100 or the system/method 900 (e.g., electronic wallet verification interface, device integrity attestation and authentication software components, verification system 204 (FIG. 2A), software components of the blockchain network 800 (FIG. 8), a minimax recursive algorithm, TPM/TEE, blockchain Layer 1 virtual machine (VM) 511 (FIG. 5), encoder/decoder, arbiter, oracle 512 (FIG. 5) or 613 (FIG. 6), ML oracle, VM oracle 210 (FIG. 2A) or 443 (FIG. 4A), smart contracts 441-442 (FIG. 4A), wallet interface, applets, authentication site, cybersecurity controller, service applications, and the like) described herein may be configured using any suitable programming language known in the art, including any high-level, object-oriented programming (OOP) language, such as Python or Solidity. The computer-based system may include instances of processes that enable execution of transactions and recordation of such transactions. It should be understood that the terms “transaction” and “exchange” are herein used interchangeably, when used within a context of digitally transferring items of value, such as digital assets, collateral assets, and/or collateral tokens, among entities associated with a blockchain network, which may be configured as blockchain computer networks, or the blockchain network 800 (FIG. 8). The system 100 or the system/method 900 may also include instances of a scoring engine and/or encoders/decoders, which can be implemented by, e.g., a server 160 and/or a client 150 that communicates with the server 160, using, for instance, SSL (secure sockets layer), HTTPS (Hypertext Transfer Protocol Secure), or any other suitable protocol known in the art.

In an example mobile implementation, a mobile agent implementation of embodiments may be provided. A client-server environment may be used to enable mobile services and electronic wallet verification services using a network server, e.g., a server 160. It may use, for instance, the Extensible Messaging and Presence Protocol (XMPP) protocol, or any other suitable protocol known to those of skill in the art, to tether a device authentication engine/agent or electronic wallet verification engine/agent 115 on a user device 150 to a server 160. The server 160 can then issue commands to the user device 150 on request. The mobile user interface framework used to access certain components of the system 100 (FIG. 1) or the system/method 900 (FIG. 9) may be based on, e.g., XHP, Javalin, and/or WURFL (Wireless Universal Resource File), or other suitable known framework(s), interface(s), and/or combinations thereof. In another example mobile implementation for the iOS operating system (OS) and its corresponding API, the Cocoa Touch API may be used to implement the client-side components 115 using Objective-C or any other suitable known high-level OOP language that adds Smalltalk-style messaging to the C programming language.

A disk storage 117 may provide non-volatile storage for the computer software instructions 115 (equivalently “OS program”) and the data 116 may be used to implement embodiments of the electronic wallet verification system 100 or the system/method 900. The system may include disk storage accessible to a server computer 160. The server computer may maintain secure access to records associated with the system/method 900. A central processing unit 112 may also be attached to the system bus 110 and provide for execution of computer instructions. In one example embodiment, the central processing unit 112 may be a secure cryptoprocessor implemented as a dedicated microprocessor configured to execute the electronic wallet verification system. The cryptoprocessor may be specialized to execute cryptographic processes within hardware to support the electronic wallet verification system. Functions may include such things as accelerating encryption processes that verify compliance with encoded rules related to a digital asset or electronic transaction, enhanced tamper, and intrusion detection, enhanced data, key protection and security enhanced memory access and I/O to facilitate transactions and/or electronic wallet verification across multiple blockchain systems.

According to an example embodiment, the processor routines 115 and the data 116 may be computer program products. For instance, aspects of the electronic wallet verification system 100 or the computer-based system/method 900 (FIG. 9) may include both server-side and client-side components.

In another example embodiment, authenticators/attesters may be contacted via, e.g., blockchain gaming systems, instant messaging applications, video conferencing systems, VOIP (voice over IP) systems, etc., all of which may be implemented, at least in part, in the software 115, 116. In another example embodiment, the client-side components interfacing with the electronic wallet verification system 100 or the system/method 900 may be implemented as an application programming interface (API), executable software component, and/or integrated component of the OS configured to provide access to an electronic wallet on a TPM executing on a client device 150.

According to an example embodiment, an electronic wallet verification system is implemented as an embedded VM, preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing failsafe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

In another example embodiment, the software implementations 115, 116 are computer program products, e.g., an application and smart contracts (generally referenced as 615), including a computer-readable medium capable of being stored on the storage device 117, which provides at least a portion of the software instructions for the electronic wallet verification system 100 or the computer-based system/method 900 (FIG. 9). Executing instances of respective software components of the system 100 or the system/method 900, such as instances of the application and/or smart contracts, may be implemented as computer program products 115, and may be installed by any suitable software installation procedure, as is well known in the art. In another embodiment, at least a portion of the system software instructions 115 may be downloaded over a wired and/or wireless connection via, for instance, a browser SSL session or through an app (whether executed from a mobile or other computing device). In other embodiments, the system 100 or the system/method 900 software components 115 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art). Such carrier medium or signals may provide at least a portion of the software instructions for the system 100 or the computer-based system/method 900.

An example embodiment includes device code executed in a TEE or TPM. A TEE or TPM is a hardware environment that runs instructions and stores data outside a main OS of a device. This protects sensitive code and data from malware or snooping with purpose-built hardware governed by an ecosystem of endorsements, beginning with a device manufacturer. The system may perform checks on the TEE or TPM, such as executing BIOS (Basic I/O System) checks, to verify that folders (e.g., wallets) stored in the TEE/TPM have not been altered by malicious actors.

FIG. 2A is a block diagram showing an example device authentication system 200 with components upon which the electronic wallet verification system 100 (FIG. 1A) or the computer-based system/method 900 (FIG. 9) may operate according to an embodiment. With these system components 200, in an embodiment, network nodes may utilize, e.g., hardened encryption and electronic wallets in endpoint user device(s) 205 through an API 204a (FIG. 2B) to the verification system 100 or 204. In an example embodiment, the user device(s) 205 may provide processing, storage, and I/O devices executing application programs and the like. According to another example embodiment, further services may be provided built on these system components 200 for device management, backup, attestation, etc. To support the system 100 or the system/method 900, in an example embodiment, registration of electronic wallets and a set of device management services for attestation, backup, and device grouping, are managed. The system components 200, e.g., electronic wallet 214 (FIG. 2B), may also interface with an applet 209 (FIG. 2B).

It would be the intent of the system 200 not to maintain mission critical data as in conventional approaches, but rather to provide a platform for seamless, yet secure, connections between the electronic wallet verification system 204 and user device(s) 205. According to an example embodiment, on one end of the system 200 is a VM oracle 210 (e.g., an embedded VM oracle), which prepares an instruction for a user device 205, and at the other is an electronic wallet, which is applet 207 that can act on that instruction. In an example embodiment, a protocol may define how these instructions and replies are constructed.

According to an example embodiment, the system 200 illustrates binding between a digital asset and multiple parties/devices. In another embodiment, the system 200 may lock features of identity, transaction, and attestation based on the electronic wallets of respective user device(s) 205.

In another example embodiment, the system 200, shown in FIG. 2B, may use a secure socket, e.g., SSL or HTTPS, to maintain a persistent connection with devices 205. In an example embodiment, such a secure socket connection or channel may be used for pairing and other attestation functions. The VM oracle 210 may be provided to/utilized on one or more blockchain networks for simplifying the encoding of a transaction. This VM oracle 210, for instance, could be implemented in a programming language, such as a high-level OOP language with dynamic semantics like Python.

According to an example embodiment, a TEE may be implemented in a user device hardware security chip separate execution environment that runs alongside a rich OS and provides security services to that rich environment. In another example embodiment, electronic wallets may be stored in a TEE. Further, in yet another example embodiment, a TEE may offer an execution space that provides a higher level of security than a rich OS. According to an example embodiment, a TEE may be implemented, for instance, as a VM, on user devices, or on network nodes.

In an example embodiment, ring manager 212 may be implemented as a service provided to end-users for managing rings (or clusters) to provide scalable execution and cross-chain deployment of electronic wallet verification system(s) 204 across multiple blockchain systems. According to another example embodiment, the electronic wallet verification system(s) 204 may be grouped into a single identity and used to backup and endorse each other. Further, in yet another example embodiment, rings may be associated with other rings to create a network of devices. According to an example embodiment, rings may be a collection of individual device public keys (as opposed to a new key). In another example embodiment, if there are not many shared devices in a network, a list of devices may be short because of the potential for increased computational and bandwidth resources that may expended, and may introduce a time cost for encrypting a transaction with all of the keys on a device list.

In an example embodiment, the electronic wallet verification system 100 (FIG. 1) or the computer-based system/method 900 (FIG. 9) may calculate, determine, or predict a trusted entity score, value, or metric. According to another example embodiment, calculating, determining, or predicting a trusted entity value may be performed using a model, such as a ML or artificial intelligence (AI) model, or any other suitable model known in the art. Further, in an example embodiment, calculating/determining/predicting a trusted entity value may be carried out by a blockchain oracle or a VM. Further, in yet another example embodiment, a trusted entity value may indicate whether and/or to what extent, a particular digital asset transaction, for instance, adheres to one or more system rules. According to an example embodiment, a trusted entity value my also or alternatively pertain to any one or more of the following associated with the transaction: an electronic wallet identifier, an electronic wallet, a node, e.g., a network node, a user device, and a user. In another example embodiment, the one or more system rules may include one or more compliance rules, such as OFAC sanctions criteria, etc. Further, in yet another example embodiment, the one or more system rules may also or alternatively include screening rules, such as blocking and/or approval rule(s) specified by particular blockchain application(s)/developer(s). According to an example embodiment, a trusted entity value may be based, in whole or in part, on a verification result in response to a compliance check request that relates to a digital asset transaction, where the compliance check request relates to an electronic wallet. Thus, for instance, in another example embodiment, if a verification result indicates that an electronic wallet associated with a compliance check request has violated one or more system rules, due to being subject to, e.g., sanctions and/or application/developer-specific blocking, a trusted entity value of 0 (zero) may be calculated based on the verification result. In an example embodiment, a trusted entity value of 0 (zero) may indicate complete or full certainty that, e.g., a digital asset transaction violates one or more system rules. Conversely, according to another example embodiment, a trusted entity value of 100 (one hundred) may indicate complete or full certainty that, e.g., a digital asset transaction complies with all system rule(s).

According to an example embodiment, a trusted entity value may be calculated or revised based on one or more different factors. In another example embodiment, a trusted entity value may be calculated at a higher value, or an existing value may be adjusted upward, if certain trust measures are taken and/or certain security mechanisms are present. Further, in yet another example embodiment, a trusted entity value may be increased, or initially calculated at some elevated value, if, e.g., a node, such as a network node 150/160 (FIG. 1A), or a user device, such as an endpoint device 205 (FIG. 2A), includes a TPM. According to another example embodiment, a trusted entity value may be increased, or initially calculated at some elevated value, if, e.g., a component needed to verify a digital asset transaction, such as a private key or an electronic wallet, is stored in a TEE.

In an example embodiment, a trusted entity value may be calculated or revised based on an existing trusted entity value. For example, according to another example embodiment, if a given electronic wallet associated with, e.g., a particular node, such as a network node, or user device, is previously assigned a trusted entity value of 0 (e.g., due to the electronic wallet violating system rule(s)), then other electronic wallets associated with the same, e.g., node or device, may have an initial trusted entity value calculated at a low value, or may have an existing trusted entity value adjusted downwards. Similarly, in yet another example embodiment, nodes or devices, e.g., user devices 205, may be grouped into or managed as rings or clusters. According to one such embodiment, when a given node or device in a ring/cluster is assigned a trusted entity value of 0 (e.g., due to the node or device violating system rule(s)), then other nodes or devices belonging to the same ring/cluster may have an initial trusted entity value calculated at a low value, or may have an existing trusted entity value adjusted downwards.

In another example embodiment, the electronic wallet verification system 200 may include the components shown in FIG. 2C. According to an embodiment, electronic wallet 220 may be implemented as a software system running on an endpoint device 205 that provides an interface to the system 200 and integrates with device TEE 208.

It should be noted that cryptocurrency wallets generally can also have known or unknown vulnerabilities. A side-channel attack, for example, is a potential vulnerability. In extreme cases, even a computer which is not connected to any network can be hacked. Modified versions of wallet apps used with emulators and simulators, or on device malware can be used by hackers to create fraudulent accounts, perform malicious transactions, or transfer cryptocurrency from one wallet app to another. Aspects of the electronic wallet verification system provide improved security, fraud prevention, and privacy protection for digital assets and transactions involving such assets.

In an example embodiment, the device TEE 208 may be a software program that executes in a hardware secured TEE. According to another example embodiment, the device TEE 208 may be specially designed to execute cryptographic functions without risk of being compromised by malware or even a device operator. Further, in yet another example embodiment, device registrar 221 may be a service that registers a device into blockchain(s)/sidechain(s) 206₁₋ₙ. In an example embodiment, the blockchain(s)/sidechain(s) 206₁₋ₙ may be used both to store device registration and attributes and to execute/encode transactions. According to another example embodiment, there may be multiple distinct blockchains forming a ring, or cluster. Further, in yet another example embodiment, the electronic wallet verification system 204 may provide robust fraud protection by only allowing access to a digital asset and/or a transaction involving a digital asset to electronic wallets that have, for instance, successfully passed a compliance and/or screening check. According to an example embodiment, Original Equipment Manufacturer (OEM) 223 may be an entity that built a user device and/or a Trusted Application Manager (TAM) authorized to cryptographically vouch for the device's provenance.

In an example embodiment, when the electronic wallet 220 software shown in FIG. 2C runs for the first time to process a digital asset or transaction, it may ask the device TEE 208 to generate a cryptographic key. Each digital asset or transaction involving the digital asset may be signed by a node that deposits the asset into a locker with their signature and is thereby locked. For a node to then interact with the digital asset or participate in the transaction on the network on which the asset is locked, the node must unlock the asset with a cryptographic signature. Registration may involve confirmation from the device operator. The registrar may request additional details about the device to further verify identify, which details may be, e.g., a Device Measurement Record including one or more of the following: a composite value of the Platform Configuration Registers (PCRs) generated by the boot process, BIOS version, OS version, and/or GPS (Global Positioning System) location, etc. This data may be signed by the cryptographic key. It may be further signed by the registrar. The resulting data set may become the gold reference or reference value for future integrity checks. Confirmation from the device operator may be required in collecting the gold reference or reference value. This data set may be posted into a public cryptographic ledger. The public record may establish cryptographic proof of the time of registration along with the endorsement of the registrar. The registration may further include attribute data, such as location, company name, and/or device make/model. The registration may reference a signed document that sets out the policy terms of the registrar at the time of registration. The device registrar 221, or another trusted integrity server, may create a blockchain account key (e.g., a public/private key pair) that can be referenced as a signatory in a transaction on the blockchain. With a signatory, the value represented in the blockchain transaction cannot be spent or transferred unless cosigned by the registrar.

According to an example embodiment, blockchain(s)/sidechain(s) 206₁₋ₙ may be, e.g., a JSON (JavaScript Object Notation) API written in Python, which may use a third-party agent/process private key to enroll identity cryptographic keys of device(s) 205 and the electronic wallet verification system 200. During enrollment, in another example embodiment, a public key of a user device 205 or the system 200 may be recorded by the TEE applet 208. Further, in yet another example embodiment, enrollment may assist the TEE applet 208 in pairing a device 205 with the electronic wallet verification system 204. According to an example embodiment, the result of pairing may be that a user device 205 has a service public key, endorsed by a third-party agent/process, and can therefore respond to verification system 204 instructions. In another example embodiment, other devices may be paired with the system 200 for transactions (e.g., access, transfer) related to a subject digital asset to be approved.

In an example embodiment, electronic wallet 214 may include outward and inward-looking interfaces as shown in FIG. 2D. An inward-looking interface, TEE adapter 216, may handle proprietary communications with the system 200. A host adapter 217 may be provided to expose services to third-party applications. The host adapter 217 may present an interface of the electronic wallet 214 through different local contexts, such as browsers or system services, among other examples. Multiple realizations for diverse contexts are envisioned. A socket adapter 215 may connect the client environment blockchain(s)/sidechain(s) 206₁₋ₙ. The TEE adapter component 216 may serve as glue that pipes commands into the system 200. The electronic wallet 214 may prepare message buffers that are piped to the system 200, and then synchronously await notification of a response event related to a digital asset or transaction. The host adapter 217 may serve primarily to isolate the TEE adapter 216 from a host environment. The host adapter 217 may operate in a potentially hostile environment. The host adapter 217's role may serve primarily to facilitate easy access to the system 200. Instructions from the electronic wallet verification system 204 intended for the system 700 may be signed by the verification system 204 and then passed through to the TEE adapter 216 and the system 700.

According to an example embodiment, the blockchain(s)/sidechain(s) 206₁₋ₙ may have a special capability of pairing additional electronic wallets with a device 205. In another example embodiment, communications with the blockchain(s)/sidechain(s) 206₁₋ₙ may be handled through a web API and preferably are authenticated. Further, in yet another example embodiment, this may be implemented with an API key. This may also be implemented using an SSL key swap. In some embodiments, all requests may be signed.

In an example embodiment, the device authentication system 200 provides robust security, fraud prevention, and privacy protection through electronic wallet verification. This should make it more difficult for an attacker to access a digital asset or a transaction involving a digital asset, because if the attacker does not properly pass compliance and/or screening checks, access to a digital asset or transaction will not be validated. Furthermore, in another example embodiment, the system 200 is preferably in near constant contact with all devices 205 through the socket adapter 215 shown in FIG. 2C.

According to an example embodiment, the blockchain(s)/sidechain(s) 206₁₋ₙ may include several subcomponents. For instance, each block on the blockchain(s)/sidechain(s) 206₁₋ₙ may include hashes, a height, a nonce value, confirmations, and and/or a Merkle Root, among other examples.

In another example embodiment, the system 200 may be configured to interface with the VM oracle 210. According to an example embodiment, the electronic wallet verification component may interface with or be coupled with the VM oracle 210. A request or instruction, e.g., from a verification system 204 or a user device 205, to access a subject digital asset (e.g., a NFT) may trigger a cryptographic key command to be executed by associated device(s). The command may be signed and/or encrypted by the system 200. The cryptographic keys from the respective devices may be preloaded into the electronic wallet verification system during a pairing process, which may be conducted by the blockchain(s)/sidechain(s) 206₁₋ₙ. This may allow the system 200 to validate an origin or source of the request, and, if needed, decrypt the contents of the instruction, and request that the other devices having cryptographic keys approve or authorize it. A quorum of cryptographic keys or all the cryptographic keys may be needed to execute a transaction related to the electronic asset (e.g., a NFT).

A sequence of packaging and delivering an instruction according to an example embodiment is shown in FIG. 3A. In an example embodiment, the electronic wallet verification system 204 may generate an instruction record with the help of the VM oracle 210 libraries. Further, in yet another example embodiment, an instruction may include a type, target device, and/or payload. According to an example embodiment, an instruction may be encoded and signed by one or more keys. In another example embodiment, one or more keys may be fetched from the blockchain(s)/sidechain(s) 206₁₋ₙ, by looking up a device registration record.

In an embodiment, device enrollment or creation of a cryptographic key stored in a TEE of a device may be performed. An example enrollment process, shown in FIG. 3B, should be hassle free, or even transparent to a user. This example embodiment may ensure that a cryptographic key processed via the electronic wallet verification system is operating in a proper TEE.

FIGS. 4A-4B are block diagrams illustrating exemplary system components 440 for the electronic wallet verification system 100 (FIG. 1A) or computer-based system 900 (FIG. 9) according to an embodiment.

As illustrated by FIG. 4A, in an example embodiment, the components 440 may include a fraud prevention computer system (not shown), a VM with a blockchain oracle, e.g., VM oracle 443 or 210 (FIG. 2A), and a first smart contract on a blockchain computer network, e.g., smart contract 442. In another example embodiment, the blockchain computer network may be, e.g., Ethereum, Tezos, Stellar, Hyperledger Fabric, ConsenSys Quorum, or any other blockchain or distributed ledger network known to those of skill in the art. To continue, according to an example embodiment, the VM oracle 443 may be configured to bridge one or more off-chain compliance and privacy protection interfaces, e.g., compliance interface(s) 445. In another example embodiment, the VM may be configured to decode, via a decoder, smart contract 442. According to an embodiment, in response to a compliance check request relating to an electronic wallet, the smart contract 442 may be configured to verify the electronic wallet by dynamically querying the compliance interface(s) 445 for the electronic wallet via a blockchain oracle, e.g., VM oracle 443 or 210.

Continuing with FIG. 4A, in an example embodiment, the compliance check request may be received from a second smart contract on the blockchain computer network, e.g., smart contract 441. According to another example embodiment, the smart contract 442 may be further configured to transmit, via the blockchain computer network, a message to the smart contract 441, where the message indicates a verification status of the electronic wallet, and where the verification status is based on a result of verifying the electronic wallet. In an example embodiment, the compliance check request may relate to a digital asset transaction. According to an example embodiment, the digital asset may be a NFT. In an embodiment, the digital asset transaction or the digital asset may be disabled in response to dynamically querying the one or more off-chain compliance and privacy protection interfaces, e.g., compliance interface(s) 445, indicating that the electronic wallet is not verified.

Referring again to FIG. 4A, in an example embodiment, the compliance interface(s) 445 may include an external sanctions database, e.g., sanctions DB 446, that is configured to store unique electronic wallet identifiers. According to another example embodiment, the sanctions DB 446 may be an OFAC sanctions database; the OFAC database may include digital wallet information such as a list of sanctioned electronic wallet addresses. In yet another example embodiment, the smart contract 442 may be further configured to store one or more unique electronic wallet identifiers retrieved from the sanctions DB 446 in an on-chain sanctions map of the blockchain computer network, e.g., sanctions map 444.

While the OFAC database of sanctioned electronic wallet addresses is discussed above, some embodiments may provide for a comprehensive screening of an electronic wallet or user device identity against one or more other OFAC databases, in addition to the database of sanctioned electronic wallet addresses. In one such embodiment, the electronic wallet or user device identity is screened or verified without, for example, accessing, inspecting, revealing, or divulging personally identifiable information (PII). According to an example embodiment, dynamically querying the one or more off-chain compliance and privacy protection interfaces, e.g., compliance interface(s) 445, via the blockchain oracle, e.g., VM oracle 443 or 210 (FIG. 2A), excludes user and personal information associated with the electronic wallet to protect user privacy. In yet another example embodiment, the first smart contract on the blockchain computer network, e.g., smart contract 442, may be further configured with a ZKP to verify that user and personal information associated with the electronic wallet is not included with the compliance check request.

Certain embodiments may thus offer techniques for verifying or checking an identity that protect, preserve, and maintain privacy. Safeguarding privacy within blockchain networks is an important consideration for traditional institutions such as banks and other financial institutions that may desire to interact with and/or launch smart contracts, for example, as part of digital asset transactions, but may also need to keep trade secrets and/or sensitive customer information etc. confidential. As to the latter, such institutions may also be required to comply with rules and/or regulations including, but not limited to, the Europe Union's General Data Protection Regulation (GDPR) and the United States' Health Insurance Portability and Accountability Act (HIPAA), among other examples.

In an example embodiment, such privacy-maintaining identity verification may be accomplished by use of, e.g., a “zero-knowledge proof” (ZKP). A ZKP implementation in the electronic wallet verification system may ensure privacy on a public blockchain and/or compliance with encoded rules configured in NFT assets by utilizing a technique whereby a first entity (or “prover”), such as a transacting entity, a network node, an electronic wallet, a user device, or a smart contract, etc., may cryptographically prove to a second entity (or “verifier”) that the first entity possesses knowledge regarding certain information, e.g., encoded rules configured in a NFT, without also disclosing the actual contents of the information.

ZKPs may be interactive or non-interactive. An interactive ZKP may require interaction between a prover entity and a verifier entity taking part in, e.g., a NFT encoded rule enforcement transaction processed by the electronic wallet verification system. A non-interactive ZKP can be constructed from any interactive scheme by leveraging, e.g., a Fiat-Shamir heuristic, or any other suitable technique known to those of skill in the art.

According to an example embodiment, a protocol implementing ZKPs may be presented as a transcript where a prover (first entity) responds to interactive inputs from a verifier (second entity). In another example embodiment, the interactive input may be in the form of one or more challenges such that responses from the prover will convince the verifier if and only if a statement is true, e.g., if the prover does possess certain asserted knowledge.

In the context of blockchain networks, according to some embodiments, by employing a ZKP, the only information divulged on-chain may be that some piece of undisclosed information is (i) valid and (ii) known by the prover with a high degree of certainty. As such, in an example embodiment, ZKPs may be used by various blockchains to furnish privacy-maintaining digital asset transactions, whereby, for example, a transaction's amount, sender electronic wallet identifier, and receiver electronic wallet identifier are kept secret. In addition, some embodiments relate to oracle networks that provide smart contracts with access to off-chain data and/or computing infrastructure. Such oracle networks may also employ ZKPs to prove a certain fact about off-chain data, without divulging the data itself on-chain. A method used for performing non-interactive ZKPs may be as described in D. Unruh, “Non-Interactive Zero Knowledge Proofs in the Random Oracle Model,” in EUROCRYPT 2015, 2015, pp. 755-84, which is herein incorporated by reference in its entirety.

Furthermore, a method for creating and executing ZKP applications in embedded systems may be as described in Salleras, et al., “ZPIE: Zero-Knowledge Proofs in Embedded Systems,” Mathematics, vol. 9, no. 20, p. 2569, 2021, which is herein incorporated by reference in its entirety.

Referring now to FIG. 4B, in an example embodiment, the one or more off-chain compliance and privacy protection interfaces, e.g., compliance interface(s) 445, may include an external application programming interface (API), e.g., external API 447. According to another example embodiment, dynamically querying the compliance interface(s) 445 for the electronic wallet via the blockchain oracle, e.g., VM oracle 443 or 210 (FIG. 2A), may include receiving a message from external API 447, where the message indicates a screening status of the electronic wallet. In an example embodiment, the external API 447 may be, e.g., a HTTPS REST (representational state transfer) API, or any other suitable API known to those of skill in the art. To continue, in an example embodiment, the screening status may indicate that a node associated with the electronic wallet is blocked or approved by a blockchain application. According to an embodiment, the first smart contract on the blockchain computer network, e.g., smart contract 442, may be further configured to store a record indicating the screening status in one or more on-chain screening maps of the blockchain computer network, e.g., screening map(s) 448a-n.

It should be noted that cryptocurrency wallets generally can also have known or unknown vulnerabilities. A side-channel attack, for example, is a potential vulnerability. In extreme cases, even a computer which is not connected to any network can be hacked. Modified versions of wallet apps used with emulators and simulators, or on device malware can be used by hackers to create fraudulent accounts, perform malicious transactions, or transfer cryptocurrency from one wallet app to another. Some embodiments of the electronic wallet verification system provide improved functionality, such as fraud detection and prevention, as well as privacy protection, for transactions involving digital assets.

FIG. 5 is a block diagram showing exemplary blockchain layers 500 according to an embodiment. The exemplary blockchain layers 500 may include infrastructure (tier 1) layer 510, data (tier 2) layer 520, network (tier 3) layer 530, consensus (tier 4) layer 540, and application (tier 5) layer 550. The infrastructure layer 510 may be a hardware layer and may include one or more VM(s) 511 and/or one or more oracle(s) 512. A VM 511 may provide a runtime environment for transaction execution in the blockchain. In an example embodiment, a VM 511 may be, for instance, stack-based and may enable untrusted code to be executed by a global P2P network of computers. An oracle 512 may provide a third-party service that connects smart contracts executing on the blockchain with off-chain data sources. For instance, the oracle 512 may query, verify, and/or authenticate one or more external data source(s) for the system 100 (FIG. 1A) and/or the computer-based system/method 900 (FIG. 9). According to an example embodiment, the external data source(s) may include, e.g., one or more legacy systems 514 and/or one or more external databases 513.

According to an example embodiment, an oracle node architecture, e.g., oracle 512, may be provided to serve ML models for smart contracts on a blockchain. Example smart contract technology may be implemented by any suitable Web3 blockchain system known in the art, such as Ethereum, Cardano®, Solana, BNB (Build N' Build) Smart Chain, Casper™, Kaleido, or Fantom.

The oracle architecture may be referred to as a “ML oracle.” The ML oracle is useful to smart contract developers who want to incorporate ML models into their smart contracts. For example, a smart contract may distribute funds based on an algorithm, and the algorithm may include a ML model that forecasts sales of a product for a given week. The smart contract may invoke an inference call to a model on the ML oracle to obtain the forecast. As a further example, there are generative arts where the generative ML model may be an integral part of an artwork. Interaction with the model to generate new images may be part of a viewing experience. One well-known ML model type used by generative art is a generative adversarial network (GAN). Using the ML oracle, the ML model may become part of an NFT, thereby enabling an interactive viewing experience.

In an example embodiment, a smart contract may request an inference call to a ML model by identifying an ML model to call, such as by providing a hash value, and an input to the model. According to another example embodiment, a model file may be uploaded to, e.g., IPFS (InterPlanetary File System) or any other suitable known storage system, by a dApp developer and a model server may download the model file, e.g., using the hash value. For the ML model server to be generic enough to serve a wide range of models, it may also take as an input parameter a model type, e.g., PyTorch, TensorFlow, scikit-learn, or any other suitable known model type, as well as an input and output specification. The input may be data directly received from the calling smart contract, or it may be received indirectly via, e.g., an IPFS URI (Uniform Resource Identifier) or any other suitable identifier known to those of skill in the art. Similarly, the output may be sent back to the smart contract, or it may be uploaded to any suitable known storage system, including, but not limited to IPFS, and the, e.g., URI, may be sent to the smart contract. For instance, a forecasting model may use the direct I/O method. An indirect I/O method employing a known storage system such as IPFS may be commonly used by computer vision/imaging models, among other examples.

In an example embodiment, the fraud prevention computer system of the electronic wallet verification system 100 or the system/method 900 may include a VM, e.g., VM 511, with a blockchain oracle, e.g., oracle 512.

Continuing with FIG. 5, the data layer 520 may interface with the infrastructure layer 510 and may include blockchain implementation 521 and transaction details 522. A blockchain is a decentralized, massively replicated database (distributed ledger), where transactions are arranged in blocks, and placed in a P2P network. The blockchain implementation 521 may include a data structure represented, for example, as a linked list of blocks, where transactions are ordered. The blockchain implementation 521's data structure may include two primary components-pointers and a linked list. Pointers are variables that refer to a location of another variable, and a linked list is a list of chained blocks, where each block has data and pointers to the previous block. Each block may contain a list of transactions that happened since a prior block. The transaction details 522 may contain information about transactions occurring on the blockchain.

The network layer 530 may interface with the data layer 520 and may also be referred to as a P2P layer or propagation layer. One purpose of the network layer 530 may be to facilitate node communication 531, such that nodes can discover each other and can communicate, propagate, and synchronize with each other to maintain a valid current state of the blockchain. A distributed P2P network, e.g., network layer 530, may be a computer network in which nodes are distributed and share the workload of the network to achieve a common purpose. Nodes in the network layer 530 may carry out the blockchain's transactions.

The consensus layer 540 may interface with the network layer 530 and may ensure that blocks are ordered, validated, and guaranteed to be in the correct sequence. A set of agreements between nodes in a distributed P2P network may be established by the consensus layer 540. The agreements result in consensus protocols or algorithms, which correspond to rules that nodes follow so as to validate transactions and create blocks in accordance with those rules. To validate a transaction, a validator, e.g., validator 541a or validator 541b, may perform a consensus algorithm, such as proof of work 542 or any other suitable algorithm known in the art. Performing the consensus algorithm may involve expending computational resources to solve a cryptographic puzzle 542. After being validated according to a consensus algorithm, a transaction may be written to the blockchain through a process of writing rights 543.

The application layer 550 may interface with the consensus layer 540 and may include customized applications and services, such as electronic wallets 551. In addition, the application layer 550 may include (not shown): smart contracts, chaincode, and decentralized apps (dApps). The application layer 550 may also include applications utilized by end users to interact with the blockchain. Such applications may be, e.g., one or more user facing interface(s) 552. Further, such applications may include, for example (not shown): scripts, APIs, and/or frameworks.

FIG. 6A is a flowchart diagram of an exemplary sequence 610 of checking an electronic wallet by the electronic wallet verification system 100 (FIG. 1A) or the computer-based system/method 900 (FIG. 9) according to an embodiment. Exemplary sequence 610 illustrates performing a “check” method call to see if an electronic wallet, e.g., an Ethereum wallet, is on a sanctioned wallet list. In an example embodiment, the call may be returned synchronously; however, method calls may also be performed asynchronously, using techniques known to those in the art. According to an embodiment, updates to the sanctioned wallet list may come from an oracle service.

As shown in FIG. 6A, according to an example embodiment, a second smart contract on a blockchain computer network, e.g., customer contract 611 or smart contract 441 (FIG. 4A), may transmit a compliance check request to a first smart contract on the blockchain computer network, e.g., wallet registry contract 612 or smart contract 442 (FIG. 4A), at 614a. In another example embodiment, the compliance check request may relate to an electronic wallet. According to an example embodiment, the wallet registry contract 612 may be decoded, via a decoder (not shown), by a VM (not shown) with a blockchain oracle, e.g., oracle service 613, VM oracle 443 (FIG. 4A), or VM oracle 210 (FIG. 2A), where the VM is in a fraud prevention computer system (not shown), and where the fraud prevention computer system is configured to protect user privacy. In another example embodiment, the oracle service 613 may be configured to bridge one or more off-chain compliance and privacy protection interfaces, e.g., compliance interface(s) 445 (FIG. 4A). According to an example embodiment, compliance interface(s) 445 may include an external sanctions database, e.g., sanctions DB 446 (FIG. 4A), configured to store unique electronic wallet identifiers. In another example embodiment, the sanctions DB 446 may be an OFAC sanctions list. According to an example embodiment, an electronic wallet may be deemed sanctioned if the wallet information or identifier is included in one or more, e.g., Know Your Customer (KYC) or KYW sanctions lists or databases, including, but not limited to, a list of OFAC sanctioned wallets, or other suitable database/list known in the art. In another example embodiment, the wallet registry contract 612 may be further configured to store one or more unique electronic wallet identifier(s) retrieved from the sanctions DB 446 in an on-chain sanctions map, e.g., sanctions map 444 (FIG. 4A), of the blockchain computer network. According to an example embodiment, transmitting the compliance check request at 614a may involve, for instance, the customer contract 611 calling a “check( )” method provided by an API, e.g., on wallet registry contract 612. To continue with the exemplary sequence 610, in another example embodiment, the wallet registry contract 612 may, in response to receiving the compliance check request relating to an electronic wallet at 614a, be configured to verify the electronic wallet by dynamically querying the compliance interface(s) 445 for the electronic wallet via the oracle service 613. According to an example embodiment, additionally or in the alternative, the wallet registry contract 612 may check internal stored data, such as the sanctions map 444, at 614b to determine if the electronic wallet has been flagged as sanctioned. In another example embodiment, if an identifier for the electronic wallet is not found in the sanctions map 444 at 614b, then at 614c the wallet registry contract 612 may emit/generate a blockchain event or log entry indicating that the electronic wallet identifier was not found in the sanctioned list/map 444. According to an example embodiment, at 614d, the wallet registry contract 612 may be further configured to transmit a message to the customer contract 611, where the message indicates a verification status of the electronic wallet, and where the verification status is based on a result of verifying the electronic wallet. Thus, as depicted at 614a-d, in an example embodiment, the customer contract 611 may assert that the wallet registry contract 612 says that an identifier for the electronic wallet is not on the sanctions list/map 444. According to another example embodiment, if the wallet registry contract 612 determines instead that the electronic wallet is sanctioned, then the assertion will fail and the digital asset transaction will error out. Otherwise, in yet another example embodiment, if the verification status of the electronic wallet is determined as not sanctioned, then the customer contract 611 may proceed with a requested operation, e.g., the digital asset transaction, for the electronic wallet with a successful check.

Referring again to FIG. 6A, in an example embodiment, at 615a, when the oracle service 613 is notified of new sanctioned electronic wallet(s), e.g., new sanctioned wallet identifier(s) in the sanctions DB 446, which may be an OFAC sanctions list, the oracle service 613 may feed the update to the wallet registry contract 612. According to another example embodiment, at 615b, the wallet registry contract 612 may further configured to store one or more unique electronic wallet identifiers retrieved from the sanctions DB 446 in the sanctions map 444. In an example embodiment, the wallet registry contract 612 may add the new sanctioned wallet identifier(s) to the sanctions map 444 when sent. According to another example embodiment, the wallet registry contract 612 may then emit/generate a blockchain event or log entry at 615c indicating that new wallet identifier(s) has/ve been added and seen.

Continuing in reference to FIG. 6A, in an example embodiment, the customer contract 611 may transmit a new compliance check request to the wallet registry contract 612 at 616a. According to another example embodiment, the wallet registry contract 612 may, in response to receiving the new compliance check request relating to the electronic wallet at 616a, be configured to verify the electronic wallet by dynamically querying the compliance interface(s) 445 for the electronic wallet via the oracle service 613. In an example embodiment, additionally or in the alternative, the wallet registry contract 612 may check internal stored data, such as the sanctions map 444, to determine if the electronic wallet has been flagged as sanctioned. According to another example embodiment, if an identifier for the electronic wallet is found in the sanctions map 444 at 616b, then at 616c, the wallet registry contract 612 may be further configured to transmit a message to the customer contract 611, where the message indicates a new verification status of the electronic wallet, and where the new verification status is based on a result of verifying the electronic wallet. Thus, as described hereinabove, the customer contract 611 may call the API “check( )” method to see if the electronic wallet has a new status.

According to an example embodiment, a compliance check request, e.g., at 614a or 616a, may relate to a digital asset transaction. According to one such embodiment, the digital asset may be a NFT.

FIG. 6B is a flowchart diagram of an exemplary sequence 620 of checking an electronic wallet and blocking the electronic wallet by the electronic wallet verification system 100 (FIG. 1A) or the computer-based system/method 900 (FIG. 9) according to an embodiment. The sequence 620 may be similar to the sequence 610 of FIG. 6A, except that sequence 620 may further include checking a blocked user list as well as a way of updating the blocked user list with an oracle service. In an example embodiment, the first smart contract on the blockchain computer network, e.g., wallet registry contract 612 or smart contract 442 (FIG. 4A), may be further configured to store a record indicating a screening status of an electronic wallet in one or more on-chain screening maps of the blockchain computer network, e.g., screening map(s) 448a-n (FIG. 4B). As described hereinabove with respect to FIG. 6A, according to another example embodiment, the wallet registry contract 612 may check internal stored data, such as sanctions map 444 (FIG. 4A), at 614b to determine if the electronic wallet has been flagged as sanctioned. Referring again to FIG. 6B, in an example embodiment, the wallet registry contract 612 may further check a blocked map, such as the screening map 448a, at 621. Thus, according to an example embodiment, an additional “blocked user” call 621 may occur during the API “check” call 614a.

Continuing with FIG. 6B, in an example embodiment, the wallet registry contract 612 may, in response to receiving a compliance check request relating to an electronic wallet, be configured to verify the electronic wallet by dynamically querying one or more off-chain compliance and privacy protection interfaces, e.g., compliance interface(s) 445 (FIG. 4A), for the electronic wallet via a blockchain oracle, e.g., oracle service 613, VM oracle 443 (FIG. 4A), or VM oracle 210 (FIG. 2A). Further, according to an example embodiment, the compliance interface(s) 445 may include an external API, e.g., external API 447 (FIG. 4B), and dynamically querying the compliance interface(s) 445 may include receiving a message from the external API 447, where the message indicates a screening status of the electronic wallet. The external API 447 may be, e.g., a HTTPS REST API, or any other suitable API known to those of skill in the art. For example, according to an example embodiment, a HTTPS REST API, such as external API 447, may call a “block user” method on the oracle service 613 at 623a, which may update the screening map 448a with an electronic wallet identifier sent. To continue with the sequence 620, in an example embodiment, the screening status may indicate that a node (or user or device) associated with the electronic wallet is blocked by a blockchain application. According to another example embodiment, the oracle service 613 may further be configured to transmit a message indicating the screening status to the wallet registry contract 612 at 623b. In turn, according to an example embodiment, the wallet registry contract 612 may be further configured to store a record indicating the screening status in the screening map 448a at 623c. In an example embodiment, the wallet registry contract 612 may emit/generate a blockchain event or log entry at 623d indicating that the record was added to the screening map 448a.

FIG. 6C is a flowchart diagram of an exemplary sequence 630 of checking an electronic wallet and approving the electronic wallet by the electronic wallet verification system 100 (FIG. 1A) or the computer-based system/method 900 (FIG. 9) according to an embodiment. The sequence 630 may be similar to the sequence 620 of FIG. 6B, except that the sequence 630 may further include checking an approved user list as well as a way of updating the approved user list with an oracle service. In an example embodiment, the first smart contract on the blockchain computer network, e.g., wallet registry contract 612 or smart contract 442 (FIG. 4A), may be further configured to store a record indicating a screening status of an electronic wallet in one or more on-chain screening maps of the blockchain computer network, e.g., screening map(s) 448a-n (FIG. 4B). As described hereinabove with respect to FIG. 6A, according to an example embodiment, the wallet registry contract 612 may check internal stored data, such as the sanctions map 444 (FIG. 4A), at 614b to determine if the electronic wallet has been flagged as sanctioned. Referring again to FIG. 6C, in an example embodiment, the wallet registry contract 612 may further check an approved map, such as the screening map 448b, at 631. Thus, according to an example embodiment, an additional “approved user” call 631 may occur during the API “check” call 614a.

Continuing with FIG. 6C, in an example embodiment, the wallet registry contract 612 may, in response to receiving a compliance check request relating to an electronic wallet, be configured to verify the electronic wallet by dynamically querying one or more off-chain compliance and privacy protection interfaces, e.g., compliance interface(s) 445 (FIG. 4A), for the electronic wallet via a blockchain oracle, e.g., oracle service 613, VM oracle 443 (FIG. 4A), or VM oracle 210 (FIG. 2A). Further, in an example embodiment, the compliance interface(s) 445 may include an external API, e.g., external API 447 (FIG. 4B), and dynamically querying the compliance interface(s) 445 may include receiving a message from the external API 447, where the message indicates a screening status of the electronic wallet. The external API 447 may be, e.g., a HTTPS REST API, or any other suitable API known to those of skill in the art. For instance, according to an example embodiment, a HTTPS REST API, such as the external API 447, may call a “approve user” method on the oracle service 613 at 632a, which may update the screening map 448b with an electronic wallet identifier sent. To continue with the sequence 630, in an example embodiment, the screening status may indicate that a node (or user or device) associated with the electronic wallet is approved by a blockchain application. According to another example embodiment, the oracle service 613 may further be configured to transmit a message indicating the screening status to the wallet registry contract 612 at 632b. In turn, according to an example embodiment, the wallet registry contract 612 may be further configured to store a record indicating the screening status in screening map 448b at 632c. Further, in yet another example embodiment, the wallet registry contract 612 may emit/generate a blockchain event or log entry at 632d indicating that the record was added to the screening map 448b.

As described hereinabove, certain embodiments may provide a two-tiered mechanism of screening or filtering electronic wallets using the electronic wallet verification system 100 (FIG. 1A) or the computer-based system/method 900 (FIG. 9). In a first tier, an application, including, but not limited to, a blockchain gaming system, may filter one or more electronic wallets. Reasons for screening an electronic wallet may be domain- and/or application-specific; moreover, the reasons or grounds may be separately determined by each application developer. For instance, according to an example embodiment, a particular application developer may opt to filter electronic wallets and/or associated user devices on grounds such as inappropriate game conduct, violating application terms of service, or submitting an inordinate or excessive number of charge-back requests. In another example embodiment, a second tier may relate to enforcing compliance rules, including, but not limited to, KYC, KYW, and anti-money laundering (AML) standards, as well as OFAC sanctions lists or databases.

One advantage, among numerous others, of the two-tiered screening mechanism according to some embodiments of the system 100 or the system/method 900 is providing a “meta” list of screened/filtered electronic wallets. In other words, according to an example embodiment, a given electronic wallet may be checked or verified in one or more different ways. These may include, for instance, whether an electronic wallet is blocked or approved for a particular blockchain application, such as a game, as well as whether an electronic wallet is in violation of various compliance rules, such as due to being included on an OFAC sanctions list or database.

FIG. 6D is a flowchart diagram of an exemplary sequence 640 of checking an electronic wallet by the electronic wallet verification system 100 (FIG. 1A) or the computer-based system/method 900 (FIG. 9) using asynchronous communication according to an embodiment. As described hereinabove with respect to FIG. 6A, the second smart contract on the blockchain computer network, e.g., customer contract 611 or smart contract 441 (FIG. 4A), may transmit a compliance check request to the first smart contract, e.g., wallet registry contract 612 or smart contract 442 (FIG. 4A), at 614a. Referring again to FIG. 6D, in an example embodiment, the wallet registry contract 612 may, upon receiving the verification request: (i) generate an identifier (ID) that corresponds to the screening request, (ii) generate a screening request event that includes the ID at 641a, and (iii) transmit a processing message that includes the ID to the customer contract 611 at 641b. According to an example embodiment, a blockchain oracle, e.g., oracle service 613, VM oracle 443 (FIG. 4A), or VM oracle 210 (FIG. 2A), may detect the screening request via a blockchain event/log entry and process the request accordingly. To continue with the sequence 640, in an example embodiment, the wallet registry contract 612 may, upon receiving an update message that includes the ID from the oracle service 613 at 642a, where the update message indicates completion of the screening request, store the ID in a screening request map (not shown) at 642b. According to another example embodiment, the wallet registry contract 612 may emit/generate a blockchain event or log entry at 642c indicating that the screening request is complete. Further, in yet another example embodiment, the wallet registry contract 612 may, upon receiving a status request that includes the ID from the customer contract 611 at 643a: (i) determine a completion status of the verification request by querying the screening request map based on the ID and (ii) transmit a status message to the customer contract 611 at 643b. Thus, as depicted at 643a-b, according to an example embodiment, the digital asset transaction may be triggered by waiting for a status check result of the compliance check request.

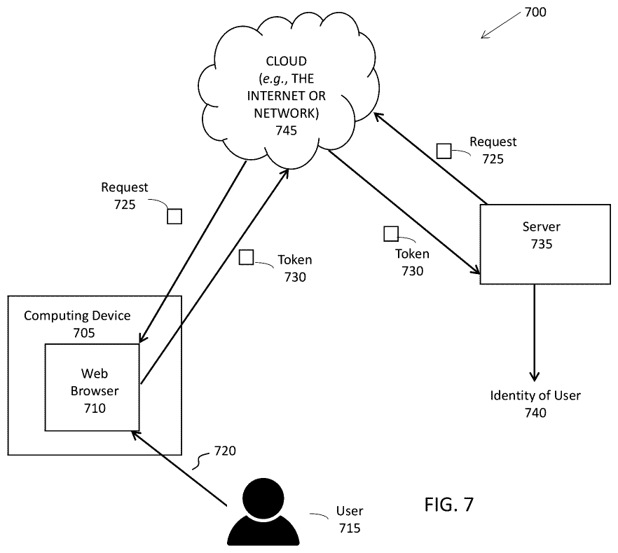

FIG. 7 shows an example of a user identification system 700 according to an embodiment. A user 715 interacts via user input 720 with a website displayed via a web browser 710 running on computing device 705, such as clicking an advertisement on the displayed website. The interaction is communicated to server (e.g., token server) 735. For example, a transparent pixel or script may be placed on the displayed website to communicate the interaction to the server 735.

An application executing on the server 735 determines whether the user 715 is a software robot or a person user by issuing a request 725 to web browser 710 to produce a token. The request 725 is sent over a network 745. In response to request 725, web browser 710 produces a token 730 on computing device 705. The token 730 is sent to the server 735 over network 745. The application executing on server 735 determines (e.g., using a computational challenge) a computational cost of producing the token 730. In some embodiments, the computational cost of producing the token 730 is based on the time taken to produce the token 730. Based on the computational cost of producing the token 730, the application on server 735 determines (deciphers) whether the user 715 is a software robot or a person user. In some embodiments, proving the computational cost of producing the token 730 at the computing device 705 is performed by an independent third party, rather than the application executing on server 735.

An application that determines whether the user 715 is software robot or a person user may also exist locally on the computing device 705. In this embodiment, it would not be necessary to send request 725 or token 730 over a network 745.

In some embodiments, the request 725 is issued in response to particular user engagement in the web browser 710 and based on user engagement metrics, including mouse movements by the user. The request 725 can also be issued in response to an elapsed period of time or issued by a web service.

In some embodiments, the application on server 735 of FIG. 7 calculates a confidence score and metrics associated with whether the user 715 operating computing device 705 is at least in part by a software robot or a person user. Once the application on server 735 determines whether user 715 is a software robot or a person user, the application on server 735 returns the identity of the user 740 and a calculated confidence score, which is associated with a likelihood of whether computing device 705 is being operated by a software robot or a person user. Thus, the calculated confidence score indicates a confidence value regarding the user identification. The confidence score helps the relying party determine a measure of confidence about the identity of the user 740.

The confidence score can be based on many different factors. One factor is the computational cost of the produced token 730. If the proven computation cost is low (below a threshold value), the confidence score may be increased. Further, if computing device 705 is a server, the computational cost is higher than if the computing device 705 is an individual machine, and thus the confidence score may be increased. The confidence score may be based on the time it took computing device 705 to produce the token 730. For example, longer times (e.g., above a time threshold) for producing token 730 may be associated with a higher likelihood that the identity of the user 740 is a software robot and a lower likelihood that the identity of the user 740 is a person user. In another embodiment, the confidence score is increased if the computing device 705 includes a TPM.

According to some embodiments, produced token 730 is captured in a cookie. In an embodiment, the captured produced token and the computational cost of the captured produced token 730 are time sensitive and expire after a period of time. Captured cookies can sign cookies generated in the future thus, building up proof of whether the web browser 710 running on computing device 705 is being operated by a person user or a bot. The building up of proof results in a longer block chain, making it increasingly difficult for a web browser running on a machine that is operated by a bot to continue to produce tokens.

In some embodiments, the confidence score may be calculated to further consider the confirmed purchase activities of the user. The score may increase when determined that a user is a verified purchaser who previously completed an online purchase. The proof of a user being an online purchaser, such as a retrieved proof of purchase cookie associating the user's identity to an entry in a database of confirmed purchases may increase the confidence score. For example, a retrieved proof of purchase cookie associating the user's identity particularly to a persistent entry in a block chain database of confirmed purchases may further increase the confidence score. That is, the trusted confirmation of the user as a verified purchaser may be associated with a higher likelihood (confidence) that the identity of the user is a person (rather than a software robot).

FIG. 8 is a block diagram of an example embodiment of a blockchain network 800, also referred to interchangeably herein as a distributed ledger network 800, that may be accessed according to an example embodiment. The blockchain network 800 is a distributed ledger P2P network and is valuable because this network enables trustworthy processing and recording of transactions without the need to fully trust any user (e.g., person, entity, program, and the like) involved in the transactions, reducing the need for trusted intermediaries to facilitate the transaction. Existing applications use the distributed ledger network 800 to transfer and record, in the form of blockchain based records, movement of tokens. Such blockchain based records form a cryptographically secured backlinked list of blocks.

The distributed ledger network 800 includes multiple computing devices configured as nodes 810, 820, 830, 840, 850, 860 of the distributed ledger network 800. Each node 810, 820, 830, 840, 850, 860 locally stores and maintains a respective identical copy 815, 825, 835, 845, 855, 865 of the blockchain ledger in memory communicatively coupled to the node. The nodes exchange messages within the distributed ledger network 800 to update and synchronize the ledger stored and maintained by each node. The nodes may also execute decentralized applications (dApps), such as via smart contracts, for processing the messages. A message transmission 870 from the node 810 to the node 840 may be used to exchange a token in the distributed ledger network 800 as shown in FIG. 8. The dotted lines between each set of nodes in the distributed ledger network 800 indicate similar transmissions that may be exchanged between any other set of nodes in the distributed ledger network 800. The messages may include a confirmed transfer for recording data associated with the token being transferred, such as a blockchain public key for each of the one or more parties participating in the transfer.

Continuing with FIG. 8, according to an example embodiment, the blockchain network 800 may be an Ethereum network; however, it should be understood that the blockchain network 800 may also be any suitable blockchain network known to those of skill in the art. Ethereum is a decentralized network of computers with two basic functions: (i) a blockchain that can record transactions and (ii) a VM, that is, an Ethereum Virtual Machine (EVM), that can produce smart contracts. Because of these two functions, Ethereum is able to support dApps. These dApps are built on the existing Ethereum blockchain, piggybacking off of its underlying technology. In return, Ethereum charges developers for the computing power in their network, which can only be paid in Ether (ETH), the only inter-platform currency. Depending on its purpose, a dApp may create ERC-20 tokens to function as a currency. According to an example embodiment, FTs disclosed herein may be ERC-20 tokens or any other suitable FT known in the art.

The code of the smart contract may be uploaded on the EVM, which may be a universal runtime compiler or browser, to execute the smart contract's code. Once the code is on the EVM, the code may be the same across each Ethereum node to be run to check whether one or more condition(s) are met, such as a condition for secure possession of respective shard(s) of a cryptographic key by corresponding node(s) of a blockchain computer network.

Ethereum has a long history of developed standards. For example, ERC-20 is a standard that defines a set of six functions that other smart contracts within the Ethereum computer-implemented ecosystem can understand and recognize. ERC-20 is a protocol standard and in order to be ERC-20 compliant, the functions need to be included in the token's smart contract. ERC-20 outlines a specific list of rules that a given Ethereum-based token has to deploy, simplifying the process of programming the functions of tokens on Ethereum's blockchain. These include, for instance, how to transfer a token (by the owner or on behalf of the owner), such as may be employed for transferring FTs of a buyer, and how to access data (e.g., name, symbol, supply, and/or balance) concerning the token.

FIG. 9 is a flow diagram of an exemplary computer-based system/method 900 for multinetwork digital asset control according to an embodiment. The system/method 900 begins by bridging 901, by a blockchain oracle of a virtual machine (VM), e.g., 443 (FIG. 4A), one or more off-chain compliance and privacy protection interfaces, e.g., 445 (FIG. 4A). In turn, the system/method 900 decodes 902, by the VM, using a decoder, a first smart contract, e.g., 441 (FIG. 4A), on a blockchain computer network. Then, in response to a compliance check request relating to an electronic wallet, the system/method 900 verifies 903, by the first smart contract on the blockchain computer network, the electronic wallet by dynamically querying the one or more off-chain compliance and privacy protection interfaces for the electronic wallet via the blockchain oracle.

Further example embodiments disclosed herein may be configured using a computer program product; for example, controls may be programmed in software for implementing example embodiments. Further example embodiments may include a non-transitory computer-readable medium containing instructions that may be executed by a processor which, when loaded and executed, cause the processor to complete methods described herein. It should be understood that elements of the block and flow diagrams may be implemented in software or hardware, such as via one or more arrangements of circuitry of FIG. 1B, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer-readable medium, such as random-access memory (RAM), read-only memory (ROM), compact disk read-only memory (CD-ROM), and so forth. In operation, a general-purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

It should be understood that the term “blockchain” as used herein includes all forms of electronic, computer-based, distributed ledgers. These include consensus-based blockchain and transaction-chain technologies, permissioned and un-permissioned ledgers, shared ledgers and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

It should also be noted that not all currently known distributed ledger systems utilize linear blockchains as such. Some known blockchain implementations utilize lattice or mesh data structure(s), and some utilize directed acyclic graphs (DAGs).

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A blockchain computer system for real-time electronic wallet verification, the blockchain computer system comprising:
a blockchain computer network including multiple nodes,
at least one of the multiple nodes including (i) at least one processor and (ii) a memory, the at least one of the multiple nodes configured to execute a fraud prevention computer system,
the fraud prevention computer system configured to protect user privacy, the fraud prevention computer system including:
a virtual machine (VM) with a blockchain oracle configured to bridge one or more off-chain compliance and privacy protection interfaces,
the virtual machine (VM) configured to decode, via a decoder, a first smart contract on a blockchain computer network; and
the first smart contract on the blockchain computer network, in response to a compliance check request relating to an electronic wallet, configured to verify the electronic wallet by dynamically querying the one or more off-chain compliance and privacy protection interfaces for the electronic wallet via the blockchain oracle.

2. The blockchain computer system of claim 1, wherein:
the compliance check request is received from a second smart contract on the blockchain computer network; and
the first smart contract on the blockchain computer network is further configured to transmit a message to the second smart contract on the blockchain computer network, the message indicating a verification status of the electronic wallet, the verification status based on a result of verifying the electronic wallet.

3. The blockchain computer system of claim 1, wherein the compliance check request relates to a digital asset transaction.

4. The blockchain computer system of claim 3, wherein the digital asset is a non-fungible token (NFT).

5. The blockchain computer system of claim 3, wherein the digital asset transaction or the digital asset is disabled in response to dynamically querying the one or more off-chain compliance and privacy protection interfaces indicating that the electronic wallet is not verified.

6. The blockchain computer system of claim 1, wherein dynamically querying the one or more off-chain compliance and privacy protection interfaces via the blockchain oracle excludes user and personal information associated with the electronic wallet to protect user privacy.

7. The blockchain computer system of claim 1, wherein the first smart contract on the blockchain computer network is further configured with a zero-knowledge proof (ZKP) to verify that user and personal information associated with the electronic wallet is not included with the compliance check request.

8. The blockchain computer system of claim 1, wherein:
the one or more off-chain compliance and privacy protection interfaces comprise an external sanctions database configured to store unique electronic wallet identifiers.

9. The blockchain computer system of claim 8, wherein:
the external sanctions database comprises an Office of Foreign Assets Control (OFAC) sanctions list; and
the unique electronic wallet identifiers comprise unique electronic wallet addresses.

10. The blockchain computer system of claim 8, wherein the first smart contract on the blockchain computer network is further configured to store one or more unique electronic wallet identifiers retrieved from the external sanctions database in an on-chain sanctions map of the blockchain computer network.

11. The blockchain computer system of claim 1, wherein:
the one or more off-chain compliance and privacy protection interfaces comprise an external application programming interface (API); and
dynamically querying the one or more off-chain compliance and privacy protection interfaces for the electronic wallet via the blockchain oracle comprises receiving a message from the external application programming interface (API), the message indicating a screening status of the electronic wallet.

12. The blockchain computer system of claim 11, wherein the screening status indicates that a node associated with the electronic wallet is blocked or approved by a blockchain application.

13. The blockchain computer system of claim 11, wherein the first smart contract on the blockchain computer network is further configured to store a record indicating the screening status in one or more on-chain screening maps of the blockchain computer network.

14. A computer-implemented method for real-time electronic wallet verification, the computer-implemented method comprising:
bridging, by a blockchain oracle of a virtual machine (VM), one or more off-chain compliance and privacy protection interfaces;
decoding, by the virtual machine (VM), using a decoder, a first smart contract on a blockchain computer network; and
in response to a compliance check request relating to an electronic wallet, verifying, by the first smart contract on the blockchain computer network, the electronic wallet by dynamically querying the one or more off-chain compliance and privacy protection interfaces for the electronic wallet via the blockchain oracle.

15. The computer-implemented method of claim 14,
wherein the compliance check request is received from a second smart contract on the blockchain computer network; and
further comprising, by the first smart contract on the blockchain computer network, transmitting a message to the second smart contract on the blockchain computer network, the message indicating a verification status of the electronic wallet, the verification status based on a result of verifying the electronic wallet.

16. The computer-implemented method of claim 14, wherein the compliance check request relates to a digital asset transaction.

17. The computer-implemented method of claim 16, wherein the digital asset is a non-fungible token (NFT).

18. The computer-implemented method of claim 16, wherein the digital asset transaction or the digital asset is disabled in response to dynamically querying the one or more off-chain compliance and privacy protection interfaces indicating that the electronic wallet is not verified.

19. The computer-implemented method of claim 14, wherein dynamically querying the one or more off-chain compliance and privacy protection interfaces via the blockchain oracle excludes user and personal information associated with the electronic wallet to protect user privacy.

20. The computer-implemented method of claim 14, further comprising:
verifying, by the first smart contract on the blockchain computer network with a zero-knowledge proof (ZKP), that user and personal information associated with the electronic wallet is not included with the compliance check request.

21. The computer-implemented method of claim 14, wherein:
the one or more off-chain compliance and privacy protection interfaces comprise an external sanctions database configured to store unique electronic wallet identifiers.

22. The computer-implemented method of claim 21, wherein:
the external sanctions database is an Office of Foreign Assets Control (OFAC) sanctions list; and
the unique electronic wallet identifiers comprise unique electronic wallet addresses.

23. The computer-implemented method of claim 21, further comprising:
storing, by the first smart contract on the blockchain computer network, one or more unique electronic wallet identifiers retrieved from the external sanctions database in an on-chain sanctions map of the blockchain computer network.

24. The computer-implemented method of claim 14, wherein:
the one or more off-chain compliance and privacy protection interfaces comprise an external application programming interface (API); and
dynamically querying the one or more off-chain compliance and privacy protection interfaces for the electronic wallet via the blockchain oracle comprises receiving a message from the external application programming interface (API), the message indicating a screening status of the electronic wallet.

25. The computer-implemented method of claim 24, wherein the screening status indicates that a node associated with the electronic wallet is blocked or approved by a blockchain application.

26. The computer-implemented method of claim 24, further comprising:
storing, by the first smart contract on the blockchain computer network, a record indicating the screening status in one or more on-chain screening maps of the blockchain computer network.
